(19) United States
(12) Patent Application Publication
(10) Pub. No.: US 2025/0174100 A1
(43) Pub. Date: May 29, 2025

(54) METHOD FOR PROVIDING NOTIFICATION AND ELECTRONIC DEVICE SUPPORTING SAME

(71) Applicant: Samsung Electronics Co., Ltd., Suwon-si (KR)

(72) Inventors: Eunbuel HAN, Suwon-si (KR); Ahra CHO, Suwon-si (KR)

(21) Appl. No.: 19/037,956

(22) Filed: Jan. 27, 2025

Related U.S. Application Data
(63) Continuation of application No. PCT/KR2023/007641, filed on Jun. 2, 2023.

(30) Foreign Application Priority Data
Aug. 2, 2022 (KR) 10-2022-0096345

(51) Int. Cl. G08B 13/22

(52) U.S. Cl. CPC G08B 13/22

(57) ABSTRACT

An electronic device is provided. The electronic device includes a communication circuitry, at least one processor including processing circuitry, and memory storing instructions. The instructions, when by the least one processor individually or collectively, may cause the electronic device to receive one or more events from one or more first electronic devices via the communication circuitry, based on times of reception of the one or more events, obtain at least one group for the one or more events, obtain a notification corresponding to the at least one group, and transmit the notification to a second electronic device through the communication circuitry.

### CROSS-REFERENCE TO RELATED APPLICATION(S)

This application is a continuation application, claiming priority under § 365 (c), of an International application No. PCT/KR2023/007641, filed on Jun. 2, 2023, which is based on and claims the benefit of a Korean patent application number 10-2022-0096345, filed on Aug. 2, 2022, in the Korean Intellectual Property Office, the disclosure of which is incorporated by reference herein in its entirety.

### BACKGROUND

### 1. Field

The disclosure relates to a method for providing a notification and an electronic device supporting the same.

### 2. Description of Related Art

The internet of things (IoT) technology may provide intelligent Internet technology services that create values in human life by collecting and analyzing data generated by devices. Through the convergence and combination of existing Internet technologies and various industries, IoT technology may be applied to fields, such as smart homes, smart buildings, smart cities, smart cars, and smart home appliances.

An electronic device may provide various services in association with one or more external electronic devices disposed in a location (or places) (e.g., home or company) registered in a server, using IoT technology. For example, when a person (or thing) intrudes into a location registered in the server, a server providing a service for providing a notification related to an event generated in a location (or place) registered in a server may receive the event related to the intrusion from external electronic devices disposed in the locations registered in the server. The server may generate a notification related to the intrusion and provide the generated notification to a user device (e.g., a smartphone) based on the event received from the one or more external electronic devices. The user device may allow the user of the user device to identify the intrusion into the registered location by outputting the notification.

The above information is presented as background information only to assist with an understanding of the disclosure. No determination has been made, and no assertion is made, as to whether any of the above might be applicable as prior art with regard to the disclosure.

### SUMMARY

A plurality of external electronic devices may be disposed at a location (e.g., home) registered in the server (e.g., a server providing a service for providing a notification related to an event occurring at a location (or place) registered in the server). When a person (or a thing) intrudes into a location registered in the server, the server may simultaneously (or continuously within a designated time) receive a plurality of events related to the intrusion from each of the plurality of external electronic devices. The server may provide a plurality of notifications respectively corresponding to the plurality of events received at the same time to the user device. The user device may output each of the plurality of notifications.

When a person intrudes into a location registered in the server, the server may continuously receive a plurality of events related to the intrusion from one external electronic device at the location registered in the server for a short time. The server may provide a plurality of notifications respectively corresponding to a plurality of events continuously received for a short period of time to the user device. The user device may output each of the plurality of notifications.

When the user device outputs each of the plurality of notifications, it may be inconvenient for the user of the user device to check more notifications. In this case, the user of the user device may cancel the service related to intrusion detection, deactivate the function related to intrusion detection performed by the user device, or ignore the notification related to intrusion detection. Accordingly, as the user of the user device does not identify an actually necessary notification related to the intrusion, the utility of the service providing the notification related to the intrusion detection may be reduced.

Aspects of the disclosure are to address at least the above-mentioned problems and/or disadvantages and to provide at least the advantages described below. Accordingly, an aspect of the disclosure is to provide a method for obtaining a group including one or more events received from one or more external electronic devices disposed in a location registered in a server and providing a notification corresponding to the obtained group, and an electronic device supporting the same.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuitry, at least one processor including processing circuitry, and memory storing instructions, wherein the instructions, when by the least one processor individually or collectively, cause the electronic device to receive one or more events from one or more first electronic devices through the communication circuitry, based on times of reception of the one or more events, obtain at least one group for the one or more events, obtain a notification corresponding to the at least one group, and transmit the notification to a second electronic device through the communication circuitry.

In accordance with another aspect of the disclosure, a method for providing a notification by an electronic device is provided. The method includes receiving one or more events from one or more first electronic devices through a communication circuitry of the electronic device, based on times of reception of the one or more events obtaining at least one group for the one or more events, obtaining a notification corresponding to the at least one group, and transmitting the notification to a second electronic device through the communication circuitry.

In accordance with another aspect of the disclosure, one or more non-transitory computer-readable storage media storing one or more computer programs including computer-executable instructions that, when executed by at least one processor of an electronic device individually or collectively, cause the electronic device to perform operations are provided. The operations include receiving one or more events from one or more first electronic devices through a communication circuitry of the electronic device; based on times of reception of the one or more events, obtaining at least one group for the one or more events; obtaining a notification corresponding to the at least one group; and transmitting the notification to a second electronic device through the communication circuitry.

In accordance with another aspect of the disclosure, an electronic device is provided. The electronic device includes a communication circuitry, a display, at least one processor including processing circuitry, and memory storing instructions. The instructions that, when by the least one processor individually or collectively, cause the electronic device to receive one or more events from one or more first electronic devices through the communication circuitry, obtain at least one group for the one or more events based on times of reception of the one or more events, obtain a notification corresponding to the at least one group, and display the notification through the display.

A method for providing a notification and an electronic device supporting the same, according to various embodiments, may obtain a group including one or more events received from one or more external electronic devices disposed in a location registered in a server and provide a notification corresponding to the obtained group, thereby enhancing a service of providing a notification and reducing the number of times in which the user repeatedly identifies the notification.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an internet-of-things (IoT) system according to an embodiment of the disclosure;

FIG. 2 is a block diagram illustrating an electronic device in a network environment according to an embodiment of the disclosure;

FIG. 3A is a view illustrating a system including a server performing an operation for providing a notification according to an embodiment of the disclosure;

FIG. 3B is a view illustrating a system including a hub device performing an operation for providing a notification according to an embodiment of the disclosure;

FIG. 4 is a block diagram illustrating an electronic device operating as a central device according to an embodiment of the disclosure;

FIG. 5 is a block diagram illustrating an electronic device for receiving a notification according to an embodiment of the disclosure;

FIG. 6 is a flowchart illustrating a method for providing a notification according to an embodiment of the disclosure;

FIG. 7 is a view illustrating a method for providing a notification according to an embodiment of the disclosure;

FIG. 8 is a view illustrating a method for providing a notification according to an embodiment of the disclosure;

FIGS. 9A, 9B, and 9C are views illustrating a method for obtaining a group based on an intrusion detection distance of one or more first electronic devices according to various embodiments of the disclosure;

FIG. 10 is a view illustrating a method for obtaining a group based on a distance between one or more first electronic devices according to an embodiment of the disclosure;

FIG. 11 is a flowchart illustrating a method for providing a notification based on settings related to the notification according to an embodiment of the disclosure;

FIG. 12 is a flowchart illustrating a method for providing a notification based on a level of the notification according to an embodiment of the disclosure;

FIG. 13 is a flowchart illustrating a method for providing a notification according to an embodiment of the disclosure;

FIG. 14 is a view illustrating a method for displaying a notification according to an embodiment of the disclosure;

FIG. 15 is a view illustrating a method for displaying a notification according to an embodiment of the disclosure; and

FIG. 16 is a view illustrating a method for displaying a notification according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

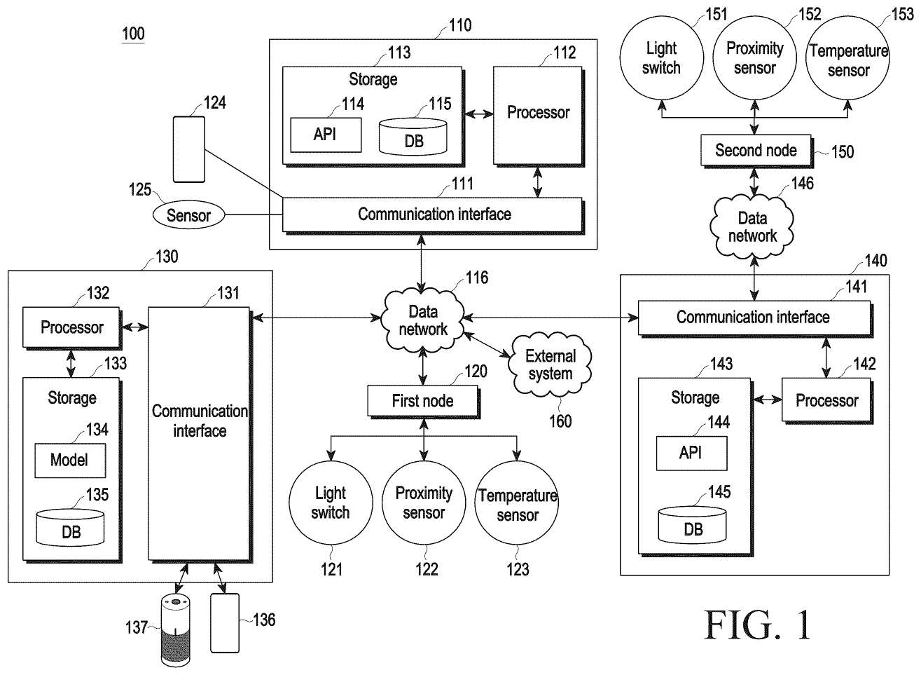

FIG. 1 illustrates an internet-of-things (IoT) system 100 according to an embodiment of the disclosure. At least some of the components shown in FIG. 1 may be omitted, or at least one component not shown may be added.

Referring to FIG. 1, the IoT system 100 includes a plurality of electronic devices connectable to a data network 116 or 146. For example, the IoT system 100 may include at least one of a first IoT server 110, a first node 120, a voice assistance server 130, a second IoT server 140, a second node 150, or devices 121, 122, 123, 124, 125, 136, 137, 151, 152, and 153.

The first IoT server 110 may include at least one of a communication interface 111, a processor 112, or a storage unit 113. The second IoT server 140 may include at least one of a communication interface 141, a processor 142, or a storage unit 143. In the disclosure, the “IoT server” may remotely control and/or monitor one or more devices (e.g., the devices 121, 122, 123, 124, 125, 136, 137, 151, 152, and 153) directly without a relay device, or via a relay device (e.g., the first node 120 or the second node 150), based on, e.g., a data network (e.g., the data network 116 or data network 146). Here, “device” refers to, e.g., a sensor, home appliance, office electronic device, or processing device placed (or positioned) in a local environment, such as a home, office, factory, building, external place, or other types of sites, and is not limited to a specific type. A device that receives a control command and performs an operation corresponding to the control command may be referred to as a “target device.” The IoT server may be referred to as a central server in light that it selects a target device from among a plurality of devices and provides control commands.

The first IoT server 110 may communicate with devices 121, 122, and 123 via the data network 116. The data network 116 may be a network for remote communication, such as, e.g., the Internet or a computer network (e.g., a local area network (LAN) or wide area network (WAN)), or may encompass cellular networks.

The first IoT server 110 may connect to the data network 116 via the communication interface 111. The communication interface 111 may include a communication device (or communication module) for supporting communication of the data network 116 and may be implemented as a single integrated component (e.g., a single chip) or as a plurality of separate components (e.g., multiple chips). The first IoT server 110 may communicate with the devices 121, 122, and 123 via the first node 120. The first node 120 may receive data from the first IoT server 110 via the data network 116 and transmit the received data to at least some of the devices 121, 122, and 123. The first node 120 may receive data from at least some of the devices 121, 122, and 123 and transmit the received data to the first IoT server 110 via the data network 116. The first node 120 may function as a bridge between the data network 116 and the devices 121, 122, and 123. Although FIG. 1 illustrates only one first node 120, this is merely an example, and embodiments of the disclosure are not limited thereto.

In the disclosure, “node” may refer to an edge computing system or a hub device. The first node 120 may support wired and/or wireless communication of the data network 116 and may support wired and/or wireless communication with the devices 121, 122, and 123. For example, the first node 120 may connect to the devices 121, 122, and 123 via a short-range communication network, e.g., at least one of Bluetooth, Wi-Fi, Wi-Fi direct, Z-wave, Zig-bee, INSETEON, X10, or infrared data association (IrDA), but the type of communication is not limited to a specific one. The first node 120 may be placed (or positioned) in an environment, such as, e.g., a home, office, factory, building, external place, or other types of sites. Thus, the devices 121, 122, and 123 may be monitored and/or controlled by a service provided by the first IoT server 110, and the devices 121, 122, and 123 may not be required to have the capability of full network communication (e.g., Internet communication) for direct connection to the first IoT server 110. Although in the illustrated example, the devices 121, 122, and 123 are implemented as electronic devices in a home environment, such as, e.g., a lamp switch, proximity sensor, and temperature sensor, this is merely an example, and the devices 121, 122, and 123 are not limited thereto.

The first IoT server 110 may also support direct communication with devices 124 and 125. Here, “direct communication” may mean communication that does not rely on a relay device, such as the first node 120. For example, “direct communication” may mean communication via, e.g., a cellular communication network and/or data network.

The first IoT server 110 may transmit control commands to at least some of devices 121, 122, 123, 124, and 125. Here, “control command” may mean data to trigger a controllable device to perform a specific operation. The specific operation may be an operation performed by a device, including outputting, sensing, reporting, or managing (e.g., deleting or creating) information, but not limited thereto. For example, the processor 112 may obtain information (or a request) for creating a control command from an outside (e.g., at least some of the voice assistance server 130, second IoT server 140, external system 160, or devices 121, 122, 123, 124, and 125) and create a control command based on the obtained information. Alternatively, the processor 112 may create a control command based on a designated condition being met by a result of monitoring of at least some of the devices 121, 122, 123, 124, and 125. The processor 112 may control the communication interface 111 to transmit the control command to the target device.

The processor 112, processor 132, or processor 142 may be implemented as a combination of one or more of general-purpose processors, such as central processing units (CPUs), digital signal processors (DSPs), application processors (APs), communication processors (CPs), graphics dedicated processors, such as graphical processing units (GPUs) or vision processing units (VPUs), or artificial intelligence dedicated processors, such as neural processing units (NPUs). The above-described processing units are merely examples. It will be easily appreciated by one of ordinary skill in the art that the processor 112 is not limited thereto as long as it is a computational means capable of executing instructions stored in the storage unit 113 and outputting the results of execution.

The processor 112 may configure a web-based interface based on the API 114 or may expose the resource managed by the first IoT server 110 to the outside. For example, the web-based interface may support communication between the first IoT server 110 and an external web service. For example, the processor 112 may allow the external system 160 to control and/or access the devices 121, 122, and 123. For example, the external system 160 may be an independent (or standalone) system that is not associated with the system 100 or is not part of the system 100. The external system 160 may be, e.g., an external server or website. However, access, by the external system 160, to the devices 121, 122, and 123 or the resource of the first IoT server 110 needs to be secured. For automated applications, the processor 112 may expose the API (114)-based API end point (e.g., universal resource locator (URL)) to the outside. As set forth above, the first IoT server 110 may transfer the control command to the target device among the devices 121, 122, and 123. The description of the communication interface 141, processor 142, the API 144 of the storage unit 143, and the database 145 of the second IoT server 140 may be substantially the same as the description of the communication interface 111, processor 112, the API 114 of the storage unit 113, and the database 115 of the first IoT server 110. The description of the second node 150 may be substantially the same as the description of the first node 120. The second IoT server 140 may transfer the control command to the target device among the devices 151, 152, and 153. The first IoT server 110 and the second IoT server 140 may be operated by the same service provider in an embodiment but, in another embodiment, the servers 110 and 140, respectively, may be operated by different service providers.

The voice assistance server 130 may transmit and receive data to/from the first IoT server 110 via the data network 116. The voice assistance server 130 may include at least one of the communication interface 131, processor 132, or storage unit 133. The communication interface 131 may communicate with a smartphone 136 or AI speaker 137 via a data network (not shown) and/or cellular network (not shown). The smartphone 136 or AI speaker 137 may include a microphone and may obtain a user voice, convert the user voice into a voice signal, and transmit the voice signal to the voice assistance server 130. The processor 132 may receive the voice signal from the smartphone 136 or AI speaker 137 via the communication interface 131. The processor 132 may process the received voice signal based on a stored model 134. The processor 132 may create (or identify) a control command using a processing result, based on information stored in the database 135. The storage unit 113, 133, or 143 may include, but is not limited to, at least one non-transitory type of storage medium of flash memory types, hard disk types, multimedia card micro types, card-type memories (e.g., secure digital (SD) or extreme digital (XD) memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

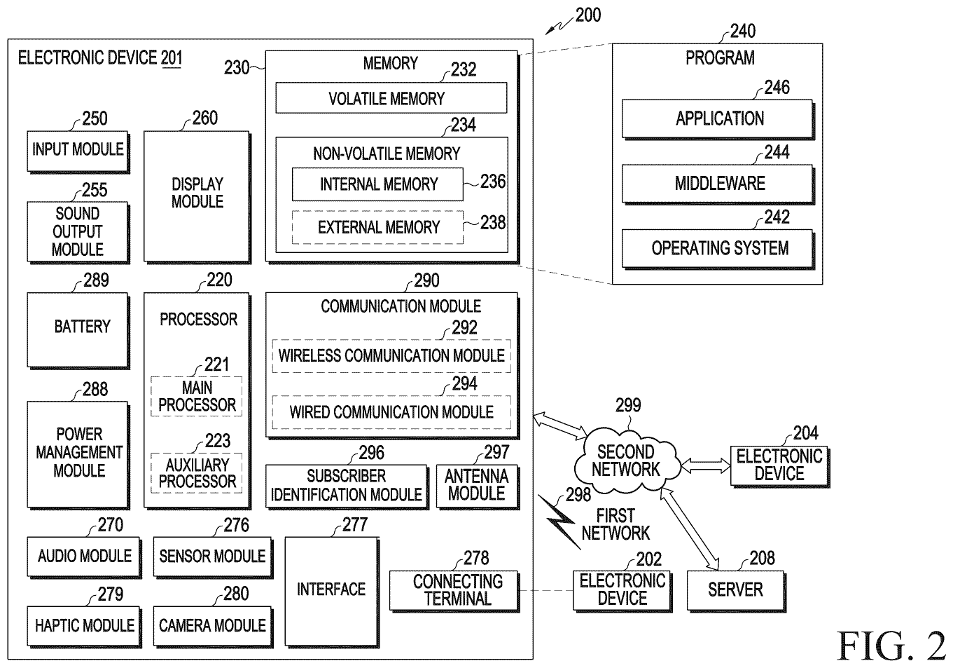

FIG. 2 is a block diagram illustrating an electronic device 201 in a network environment 200 according to an embodiment of the disclosure.

Referring to FIG. 2, the electronic device 201 in the network environment 200 may communicate with at least one of an electronic device 202 via a first network 298 (e.g., a short-range wireless communication network), or an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In an embodiment, at least one (e.g., the connecting terminal 278) of the components may be omitted from the electronic device 201, or one or more other components may be added in the electronic device 201. According to an embodiment, some (e.g., the sensor module 276, the camera module 280, or the antenna module 297) of the components may be integrated into a single component (e.g., the display module 260).

The processor 220 may execute, for example, software (e.g., a program 240) to control at least one other component (e.g., a hardware or software component) of the electronic device 201 coupled with the processor 220, and may perform various data processing or computation. According to one embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be configured to use lower power than the main processor 221 or to be specified for a designated function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 123. According to an embodiment, the auxiliary processor 223 (e.g., the neural processing unit) may include a hardware structure specified for artificial intelligence model processing. The artificial intelligence model may be generated via machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by other component (e.g., the processor 220) of the electronic device 201, from the outside (e.g., a user) of the electronic device 201. The input module 250 may include, for example, a microphone, a mouse, a keyboard, keys (e.g., buttons), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display 260 may include a touch sensor configured to detect a touch, or a pressure sensor configured to measure the intensity of a force generated by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or motion) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to an embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device 204 via a first network 298 (e.g., a short-range communication network, such as Bluetooth™, wireless-fidelity (Wi-Fi) direct, or infrared data association (IrDA)) or a second network 299 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 292 may identify or authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the millimeter wave (mmWave) band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 297 may transmit or receive a signal or power to or from the outside (e.g., the external electronic device). According to an embodiment, the antenna module 297 may include one antenna including a radiator formed of a conductor or conductive pattern formed on a substrate (e.g., a printed circuit board (PCB)). According to an embodiment, the antenna module 297 may include a plurality of antennas (e.g., an antenna array). In this case, at least one antenna appropriate for a communication scheme used in a communication network, such as the first network 298 or the second network 299, may be selected from the plurality of antennas by, e.g., the communication module 290. The signal or the power may then be transmitted or received between the communication module 290 and the external electronic device via the selected at least one antenna. According to an embodiment, other parts (e.g., radio frequency integrated circuit (RFIC)) than the radiator may be further formed as part of the antenna module 297.

According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 201 and the external electronic device 204 via the server 208 coupled with the second network 299. The external electronic devices 202 or 204 each may be a device of the same or a different type from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an Internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

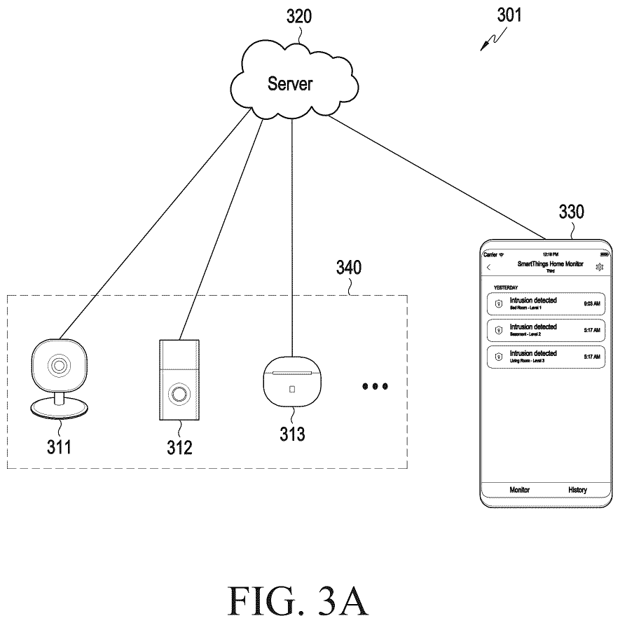

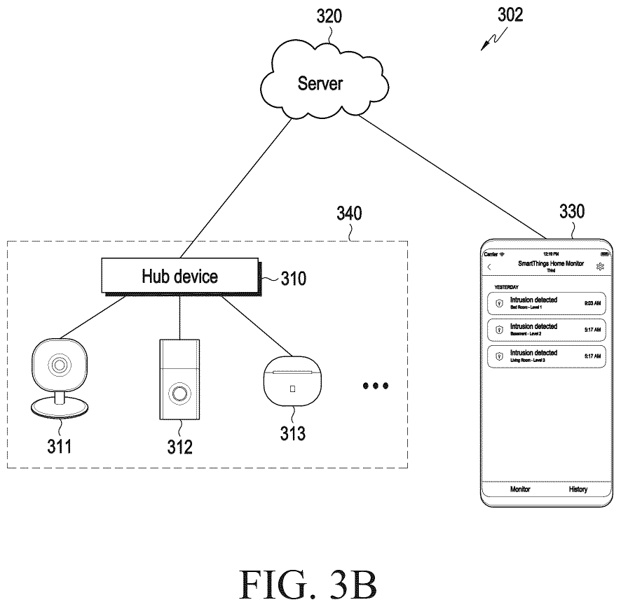

FIG. 3A is a view illustrating a system 301 including a server performing an operation for providing a notification according to an embodiment of the disclosure.

FIG. 3A may be a view illustrating a system 301 (e.g., the IoT system 100 of FIG. 1) including a server when an electronic device (hereinafter, referred to as a “central device”) performing an operation for providing a notification is a server.

Referring to FIG. 3A, the system 301 may include one or more first electronic devices 311, 312, and 313 (e.g., the devices 121, 122, 123, 151, 152, and 153), a server 320 (e.g., the first IoT server 110 or the second IoT server 140), and a second electronic device 330 (e.g., the smartphone 136).

The one or more first electronic devices 311, 312, and 313 may include electronic devices registered in the server 320 in association with the location 340 registered in the server 320 and/or a room registered in the server 320. For example, the one or more first electronic devices 311, 312, and 313 are devices disposed in a location registered in the server 320 and/or a room registered in the server 320, and may include electronic devices registered in the server 320 through a registration procedure (e.g., an onboarding procedure) to the server 320.

The location 340 registered in the server 320 may refer to a place (e.g., home or company) registered in the server 320, and the room registered in the server 320 may refer to a room (e.g., living room or room 1) included in the location (e.g., home) registered in the server 320. For example, when the location registered in the server 320 is referred to as a place, the room registered in the server 320 may be referred to as a sub place or a small place included in the location registered in the server 320.

The one or more first electronic devices 311, 312, and 313 may be registered in the server 320. For example, the second electronic device 330 (e.g., a smartphone) may perform communication with the server 320 using the account of the user of the second electronic device 330 while an application providing a function for providing a notification (e.g., a function for providing a notification related to intrusion detection) is executed. While communicating with the server 320 is performed, the second electronic device 330 may allow the one or more first electronic devices 311, 312, and 313 to be registered in the server 320 in association with the account of the user of the second electronic device 330 using a scheme of searching for one or more first electronic devices 311, 312, and 313 and inputting personal identification numbers (PINs) related to the searched one or more first electronic devices 311, 312, and 313, a scheme using an encryption code (e.g., a QR code) related to the one or more first electronic devices 311, 312, and 313, or a scheme in which the user directly (manually) inputs information about the one or more first electronic devices 311, 312, and 313 and inputs the PINs related to the one or more first electronic devices 311, 312, and 313. However, the method for registering the one or more first electronic devices 311, 312, and 313 in the server 320 is not limited to the above-described examples.

The one or more first electronic devices 311, 312, and 313 may be registered in association with a location (e.g., a home) and/or a room (e.g., a living room). For example, the registration information for the one or more first electronic devices 311, 312, and 313 to the server 320 may be input by the user of the second electronic device 330 and may include the location and/or the room in which the one or more first electronic devices 311, 312, and 313 are disposed.

The one or more first electronic devices 311, 312, and 313 may be electronic devices capable of providing an event related to intrusion detection. For example, the one or more first electronic devices 311, 312, and 313 may include a camera for providing an image related to intrusion, a door lock for detecting contact from the outside and/or door opening/closing, and/or a door open sensor for detecting door opening/closing. However, the disclosure is not limited thereto. For example, in addition to the above-described devices, the one or more first electronic devices 311, 312, and 313 may include all electronic devices capable of detecting intrusion (e.g., capable of generating an event related to intrusion detection when intrusion is detected), such as a motion sensor capable of detecting movement and a sound sensor capable of detecting sound.

In the above-described examples, the one or more first electronic devices 311, 312, and 313 are illustrated as electronic devices capable of providing an event related to intrusion detection, but they are not limited thereto. For example, the one or more first electronic devices 311, 312, and 313 may include all electronic devices capable of generating an event related to the state of the location and/or room registered in the server 320, such as smoke, carbon monoxide, and/or a water leakage.

When an event related to intrusion detection occurs in the one or more first electronic devices 311, 312, and 313, the one or more first electronic devices 311, 312, and 313 may transmit the occurring event to the server 320 directly (e.g., through an access point (AP) supporting Wi-Fi or through cellular communication) or through a hub device (e.g., the hub device 310 of FIG. 3B).

The server 320 may perform an operation for providing a notification. For example, the server 320 may register the one or more first electronic devices 311, 312, and 313 in a service (e.g., a service related to intrusion detection) provided by the server 320. By registering the one or more first electronic devices 311, 312, and 313 in the server 320, the server 320 may store registration information about the one or more first electronic devices 311, 312, and 313 (e.g., identification information about the one or more first electronic devices 311, 312, and 313, the location and/or the room associated with the one or more first electronic devices 311, 312, and 313, and/or the capability (or function) of each of the one or more first electronic devices 311, 312, and 313) in memory (not shown) of the server 320. The identification information about the one or more first electronic devices 311, 312, and 313 may include a media access control (MAC) address (e.g., “aaa:bb:cc:dd:ee:ff”), a Wi-Fi service set identifier (SSID), and/or a serial number (SN) (e.g., “XY123”). As another example, the server 320 may receive, from the one or more first electronic devices 311, 312, and 313, one or more events (e.g., events related to intrusion detection) occurring in the one or more first electronic devices 311, 312, and 313. The server 320 may obtain (e.g., generate) at least one group for the one or more events, based on the times of the one or more events. The server 320 may transmit a notification corresponding to the at least one group to the second electronic device 330. However, the operation for providing the notification performed by the server 320 is not limited to the above-described examples, and is described below in detail.

The second electronic device 330 may be an electronic device that receives a notification from the server 320. For example, the second electronic device 330 may allow the one or more first electronic devices 311, 312, and 313 to be registered in the server 320 using the account of the user of the second electronic device 330. When an event is obtained from the one or more first electronic devices 311, 312, and 313, the second electronic device 330 may receive a notification corresponding to the group obtained based on the obtained event from the server 320. The second electronic device 330 may output the received notification. A method of outputting the received notification by the second electronic device 330 is described below.

FIG. 3B is a view illustrating a system (e.g., the IoT system 100 of FIG. 1) including a hub device performing an operation for providing a notification according to an embodiment of the disclosure.

FIG. 3B illustrates a system 302 including a hub device 310 when a central device performing an operation for providing a notification is a hub device.

Referring to FIG. 3B, when the hub device 310 is implemented as a central device (or when the hub device operates as the central device), the hub device 310 may perform at least some of the operations of the server illustrated in FIG. 3A. For example, instead of the server 320, the hub device may perform at least a part of an operation for providing a notification by the server 320 illustrated in FIG. 3A.

The hub device 310 as the central device may register one or more first electronic devices 311, 312, and 313 for a service of providing a notification. For example, the hub device 310 may store registration information about the one or more first electronic devices 311, 312, and 313 (e.g., identification information about the one or more first electronic devices 311, 312, and 313, the location 340 and/or the room associated with the one or more first electronic devices 311, 312, and 313, and/or the capability (or function) of each of the one or more first electronic devices 311, 312, and 313) in memory (not shown) of the hub device 310.

The hub device 310 as the central device may receive, from the one or more first electronic devices 311, 312, and 313, one or more events (e.g., events related to intrusion detection) occurring in the one or more first electronic devices 311, 312, and 313. The hub device 310 may obtain (e.g., generate) at least one group for the one or more events, based on the times of the one or more events. The hub device 310 may transmit a notification corresponding to the obtained group to the second electronic device 330 through the server 320, based on the at least one event.

The hub device 310 may support communication between the one or more first electronic devices 311, 312, and 313 and the server 320 using communication such as ZigBee, Z-wave, and/or local area network (LAN). However, the disclosure is not limited thereto, and the hub device 310 may include an access point (AP) that supports communication between the one or more first electronic devices 311, 312, and 313 and the server 320 through Wi-Fi.

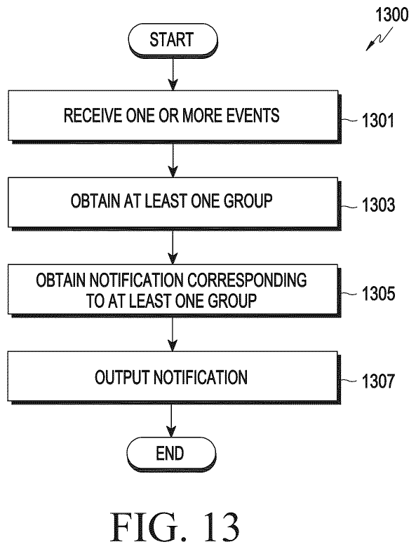

Although FIGS. 3A and 3B illustrate that the server 320 or the hub device 310 performs an operation for providing a notification as a central device, the disclosure is not limited thereto. For example, the second electronic device 330 (e.g., a smartphone) may perform at least some of operations performed by the server 320 or the hub device 310 as a central device. An example in which the second electronic device 330 performs an operation of providing a notification is described below in detail with reference to FIG. 13.

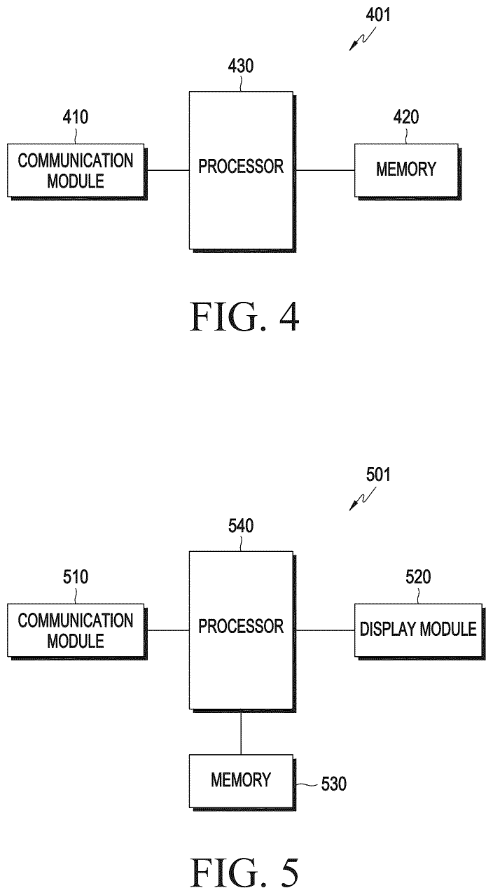

FIG. 4 is a block diagram illustrating an electronic device operating as a central device according to an embodiment of the disclosure. For example, FIG. 4 may be a block diagram of an electronic device 401 (e.g., the server 320 of FIG. 3A or the hub device 310 of FIG. 3B) operating as a central device.

Referring to FIG. 4, the electronic device 401 may include a communication module 410, memory 420, and/or a processor 430.

The communication module 410 may be a component identical or similar to the communication module 290 of FIG. 2. The communication module 410 may allow the electronic device 401 to perform communication with an external electronic device (e.g., the one or more first electronic devices 311, 312, 313 and/or the second electronic device 330 of FIGS. 3A and 3B).

The memory 420 may be a component identical or similar to the memory 230 of FIG. 2. The memory 420 may store information for performing at least a part of an operation for providing a notification. For example, the memory 420 may include instructions that enable the processor 430 to perform an operation for providing a notification.

The processor 430 may be a component identical or similar to the processor 220 of FIG. 2. The processor 430 may control an overall operation for providing a notification. In an embodiment, the processor 430 may include one or more processors for performing an operation for providing a notification.

FIG. 4 illustrates that the electronic device 401 includes the communication module 410, the memory 420, and/or the processor 430, but embodiments of the disclosure are not limited thereto. For example, the electronic device 401 may further include at least one component illustrated in FIG. 2, in addition to the components illustrated in FIG. 4.

FIG. 5 is a block diagram illustrating an electronic device 501 receiving a notification according to an embodiment of the disclosure. For example, FIG. 5 may be a block diagram of the second electronic device 330 of FIGS. 3A and 3B.

Referring to FIG. 5, the electronic device 501 may include a communication module 510, a display module 520, memory 530, and/or a processor 540.

The communication module 510 may be a component identical or similar to the communication module 290 of FIG. 2. The communication module 510 may allow the electronic device 501 to perform communication with an external electronic device (e.g., the one or more first electronic devices 311, 312, 313 and/or the server 320 of FIGS. 3A and 3B).

The display module 520 may be a component identical or similar to the display module 260 of FIG. 2. The display module 520 may display a notification received from the server 320. The display module 520 may display a screen for registering an external electronic device (e.g., one or more first electronic devices 311, 312, and 313 of FIGS. 3A and 3B) in the server 320 or a screen for making a setting for providing a notification.

The memory 530 may be a component identical or similar to the memory 230 of FIG. 2. The processor 540 may be a component identical or similar to the processor 220 of FIG. 2. According to an embodiment of the disclosure, the processor 540 may include one or more processors.

When the electronic device 501 performs at least some of the operations performed by the server 320 or the hub device 310 as the central device, the processor 540 may control the overall operation of the electronic device 501. This is described below with reference to FIG. 13.

FIG. 5 illustrates that the electronic device 501 includes the communication module 510, the display module 520, the memory 530, and/or the processor 540, but embodiments of the disclosure are not limited thereto. For example, the electronic device 501 may further include at least one component illustrated in FIG. 2, in addition to the components illustrated in FIG. 5.

An electronic device (e.g., the electronic device 401) according to various embodiments may comprise a communication module (e.g., the communication module 410) and at least one processor (e.g., the processor 430) operatively connected with the communication module (e.g., the communication module 410). The at least one processor (e.g., the processor 430) may be configured to receive one or more events from one or more first electronic devices (e.g., the one or more electronic devices 311, 312, and 313) through the communication module (e.g., the communication module 410), obtain at least one group for the one or more events with respect to the times of reception of the one or more events, obtain a notification corresponding to the at least one group, and transmit the notification to a second electronic device (e.g., the second electronic device 330) through the communication module (e.g., the communication module 410).

According to various embodiments, the at least one processor (e.g., the processor 430) may be configured to obtain a group including a first event included in the one or more events and at least one event received within a designated time from a time of reception of the first event.

According to various embodiments, the at least one processor (e.g., the processor 430) may be configured to obtain the at least one group for the one or more events based on a location and/or a room where the one or more first electronic devices are registered in the electronic device and the times of reception of the one or more events.

According to various embodiments, the at least one processor (e.g., the processor 430) may be configured to obtain the at least one group for the one or more events based on whether there is an area where ranges in which the one or more first electronic devices are able to obtain an event overlap each other and the times of reception of the one or more events.

According to various embodiments, the at least one processor (e.g., the processor 430) may be configured to obtain the at least one group for the one or more events based on a distance between the one or more first electronic devices and the times of reception of the one or more events.

According to various embodiments, the at least one processor (e.g., the processor 430) may be configured to determine whether to transmit the notification to the second electronic device based on a setting related to the notification and transmit the notification to the second electronic device through the communication module (e.g., the communication module 410) when it is determined to transmit the notification to the second electronic device.

According to various embodiments, the setting related to the notification may include a setting about whether the second electronic device receives the notification and/or a setting about a time interval for receiving the notification.

According to various embodiments, the at least one processor (e.g., the processor 430) may be configured to determine the level of the notification and transmit the notification to the second electronic device through the communication module (e.g., the communication module 410) when the level of the notification is a designated level or more.

According to various embodiments, the at least one processor (e.g., the processor 430) may be configured to determine the level of the notification based on at least one of a capability of the one or more first electronic devices, a type of the one or more events, a probability of malfunction of the one or more first electronic devices, or a sensibility set for the one or more first electronic devices.

According to various embodiments, the one or more events may be events related to intrusion detection, and the electronic device is a hub device (e.g., the hub device 310) communicatively connected to the one or more first electronic devices or a server (e.g., the server 320).

An electronic device 501 according to various embodiments may comprise a communication module 510, a display module 520, and at least one processor (e.g., the processor 540) operatively connected with the communication module 510 and the display module 520. The at least one processor (e.g., the processor 540) may be configured to receive one or more events from one or more first electronic devices (e.g., the one or more electronic devices 311, 312, and 313) through the communication module, obtain at least one group for the one or more events with respect to the times of reception of the one or more events, obtain a notification corresponding to the at least one group, and display the notification through the display module 520.

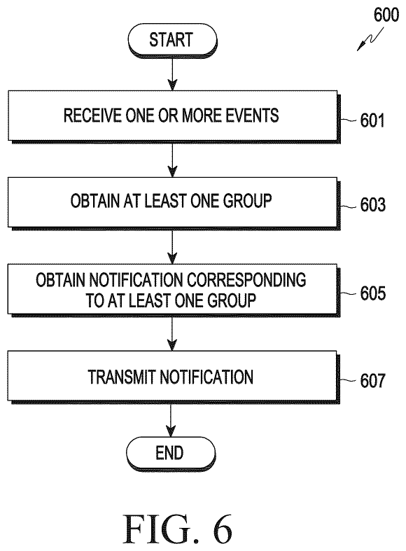

FIG. 6 is a flowchart illustrating a method for providing a notification according to an embodiment of the disclosure.

Referring to FIG. 6, the illustrated flowchart 600 is merely an embodiment, and the operation order according to various embodiments of the disclosure may be different from that illustrated in FIG. 6, and one or more of the operations illustrated in FIG. 6 may be omitted, the order between the operations may be changed, or the operations may be merged.

Referring to FIG. 6, in operation 601, the processor 430 may receive one or more events from one or more first electronic devices (e.g., the one or more first electronic devices 311, 312, and 313) through the communication module 410.

The processor 430 may receive one or more events occurring in each of the one or more first electronic devices from the one or more first electronic devices through the communication module 410. For example, the processor 430 may receive an event occurring in electronic device 1 from electronic device 1 through the communication module 410, and may receive an event occurring in electronic device 2 from the electronic device 2.

The one or more first electronic devices may be electronic devices registered in an electronic device (e.g., the server 320 of FIG. 3A or the hub device 310 of FIG. 3B) operating as a central device for a service providing a notification.

The service providing the notification may include a service related to intrusion detection (also referred to as a “home security service”). However, the service providing the notification may be a service (also referred to as a “home monitor service”) including a service related to intrusion detection and a service providing a notification on occurrence of smoke, carbon monoxide, and/or water leakage.

The one or more events (hereinafter, referred to as “one or more events”) received from the one or more first electronic devices may include one or more events related to intrusion detection. For example, the one or more events may include intrusion detection-related events, such as contact, door opening, movement, and/or sound detection, according to the type of the one or more first electronic devices. However, events related to intrusion detection are not limited to the above-described examples. The one or more events may include an event related to detecting smoke, carbon monoxide, and/or water leakage.

In operation 603, in an embodiment, the processor 430 may obtain at least one group for the one or more events, based on the times of reception of the one or more events received from the one or more first electronic devices.

The processor 430 may obtain at least one group by classifying the one or more events based on the times of reception of the one or more events received from the one or more first electronic devices. For example, when the processor 430 obtains an event (hereinafter, referred to as a “first event”) first obtained (e.g., first received by the electronic device) among the one or more events, the processor 430 may wait for a designated time (hereinafter, referred to as a “designated time”) with respect to the time when the first event is obtained (e.g., from the time when the first event is obtained), without immediately transmitting a notification corresponding to the first event to the second electronic device. When at least one event is obtained within a designated time with respect to the time when the first event is obtained, the processor 430 may obtain one group including the first event and at least one event obtained within the designated time with respect to the time when the first event is obtained. When the event is not obtained within the designated time with respect to the time when the first event is obtained, the processor 430 may obtain one group including only the first event. The processor 430 may obtain a group different from the group including the first event (e.g., a group including at least one event obtained after the designated time elapses with respect to the time when the first event is obtained) for at least one event obtained after the designated time elapses with respect to the time when the first event is obtained.

The designated time may be designated using a default time. For example, the processor 430 may designate the default time (e.g., about 1 minute) as a time for obtaining a group (e.g., one group including at least one event).

The designated time may be designated (or adjusted) based on an input of the user (e.g., the user of the second electronic device receiving a notification) input from the second electronic device (e.g., the second electronic device 330). For example, the second electronic device may designate a time for obtaining a group within a range of about 1 second to about 60 seconds, based on a user input, while an application related to a service providing a notification is executed. The second electronic device may transmit the designated time to the electronic device 401 so that the designated time is registered in the electronic device 401 (e.g., the central device).

The processor 430 may change (or adjust) the designated time according to whether the second electronic device (or the user of the second electronic device) is positioned (or is present) in the room or the location registered in the electronic device 401 (e.g., the central device). For example, when the time for obtaining the group is designated as the first time, the processor 430 may maintain the time for obtaining the group as a first time when the second electronic device (or the user of the second electronic device) is positioned in the home registered in the electronic device 401, and may change the time for obtaining the group to a second time shorter than the first time when the second electronic device is not positioned in the home registered in the electronic device 401. However, the disclosure is not limited thereto, and when the second electronic device is not positioned in the home registered in the electronic device 401, the processor 430 may change the time for obtaining the group to a third time longer than the first time.

The first event serving as the reference of the designated time may be an event first received after previously obtaining a group. For example, the processor 430 may obtain a first group including a second event and a third event received before receiving the first event. After obtaining the first group, the processor 430 may obtain a second group including the first event and a fourth event obtained after the first event within the designated time with respect to the first event first received. However, the disclosure is not limited thereto. For example, the first event serving as the reference of the designated time may be an event first received from at least one first electronic device registered in the electronic device 401 (e.g., the central device) after an application related to a service providing a notification is executed.

The processor 430 may obtain at least one group based on the times of reception of the one or more events received from the one or more first electronic devices, and the location and/or room where the one or more first electronic devices are registered in the electronic device (e.g., the central device).

The processor 430 may obtain at least one group based on the times of reception of the one or more events received from the one or more first electronic devices, for each location (e.g., home or company) where the one or more first electronic devices are registered in the electronic device 401 (e.g., central device). For example, the one or more first electronic devices may include electronic device 1 and electronic device 2 registered in the electronic device 401 in association with a home, and electronic device 3 registered in the electronic device in association with a company. After receiving event 1 from electronic device 1, if event 2 is received from electronic device 2 and event 3 is received from electronic device 3 within the designated time with respect to the time of reception of event 1, the processor 430 may obtain group 1 including event 1 and event 2 received from electronic device 1 and electronic device 2 registered in association with the home, and may obtain group 2 including event 3 received from electronic device 3 registered in association with the company and different from group 1. As another example, the one or more first electronic devices may include electronic device 4 and electronic device 5 registered in the electronic device 401 in association with room 1, and electronic device 6 registered in the electronic device in association with room 2. After receiving event 4 from the electronic device 4, when event 5 is received from electronic device 5 and event 6 is received from electronic device 6 within the designated time with respect to the time of reception of event 4, the processor 430 may obtain group 3 including event 4 and event 5 received from electronic device 4 and electronic device 5 registered in association with room 1, and may obtain group 4 including event 6 received from electronic device 6 registered in association with room 2 and different from group 3.

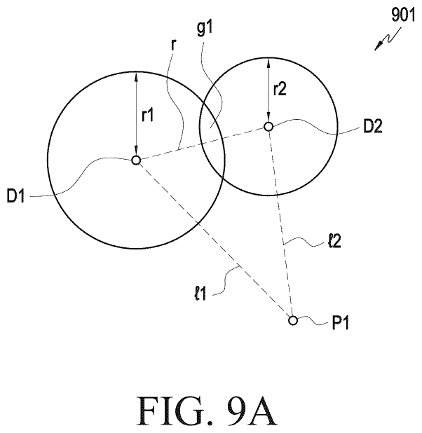

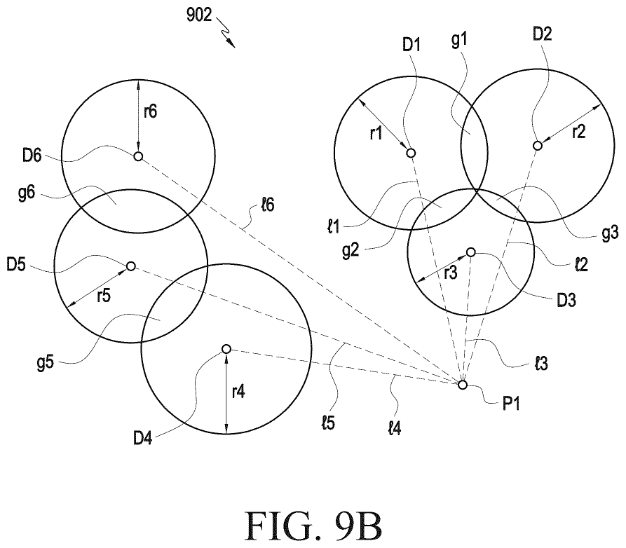

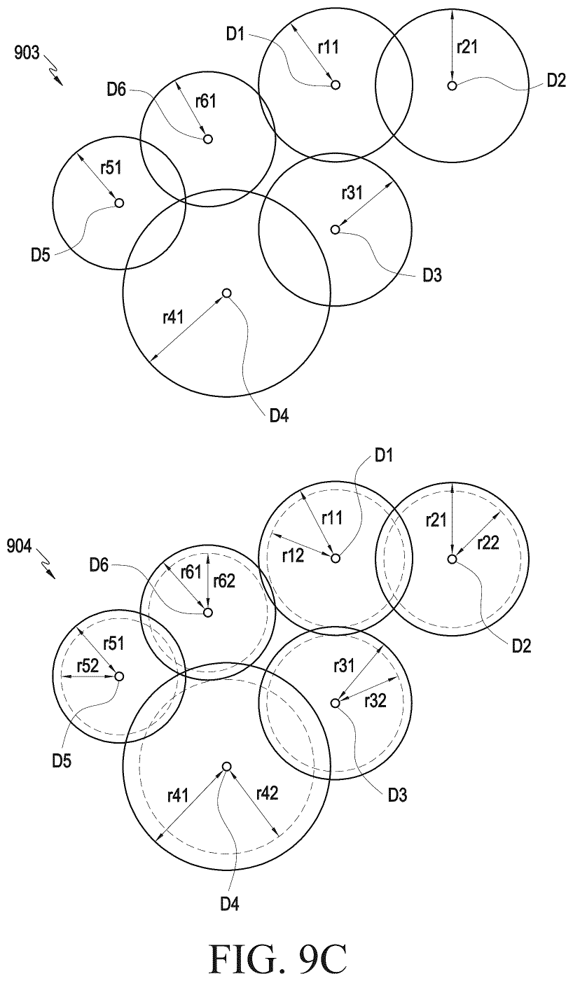

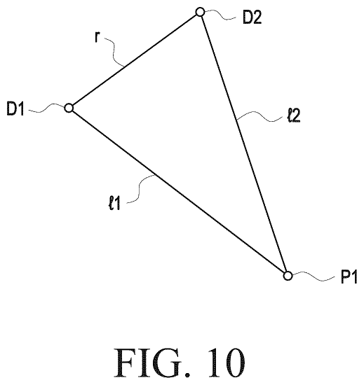

However, a method for obtaining at least one group, by the processor 430, based on one or more events is not limited to the above-described example. For example, the processor 430 may obtain at least one group for one or more events based on an intrusion detection distance of one or more first electronic devices communicatively connected using Ultra-wideband (UWB) communication or a distance between the one or more first electronic devices. An operation in which the processor 430 obtains at least one group for one or more events based on an intrusion detection distance (or an intrusion detection range) of one or more first electronic devices communicatively connected using UWB communication is described below with reference to FIGS. 9A to 9C. An operation in which the processor 430 obtains at least one group for one or more events based on a distance between one or more first electronic devices communicatively connected using UWB communication is described below with reference to FIG. 10.

In operation 605, the processor 430 may obtain a notification corresponding to at least one group. For example, the processor 430 may obtain (e.g., generate) at least one notification respectively corresponding to the at least one group.

When at least one group is obtained through operation 603, the processor 430 may obtain one notification related to (e.g., combining (or integrating) at least one event) at least one event included in the group for each of the at least one group. For example, when the at least one group includes a first group and a second group, the processor 430 may obtain a first notification indicating at least one event included in the first group, and may obtain a second notification indicating at least one event included in the second group.

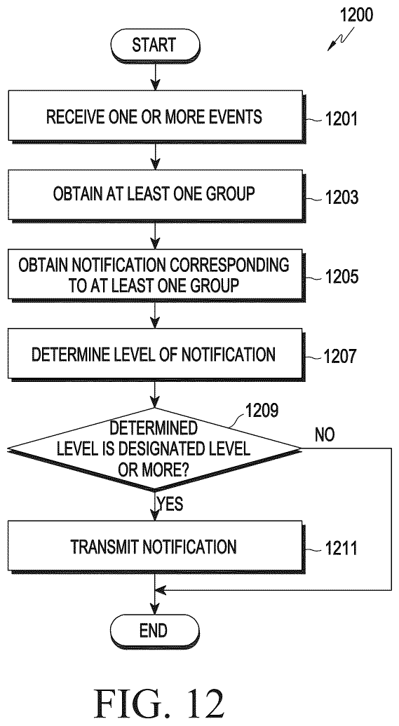

When a notification corresponding to at least one group is obtained, the processor 430 may obtain the level of the obtained notification. The level of the notification may refer to, e.g., a level (or step) indicating the degree of risk (level of risk) of intrusion. An example related to the level of the notification is described below with reference to FIG. 12.

In operation 607, the processor 430 may transmit a notification to the second electronic device (e.g., the second electronic device 330) through the communication module 410. For example, the processor 430 may transmit a notification including information (e.g., an alarm or an alert) indicating that an intrusion is detected to the second electronic device (e.g., the electronic device of the user) registered in the electronic device 401 (e.g., the central device) through the communication module 410.

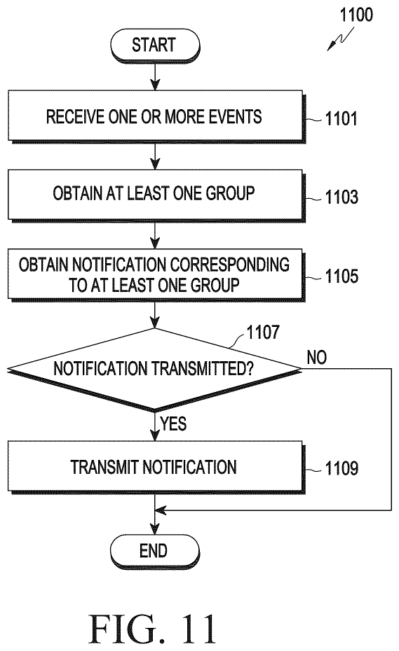

The processor 430 may not provide the obtained notification to the second electronic device, based on the setting related to the service providing the notification. This is described below with reference to FIG. 11.

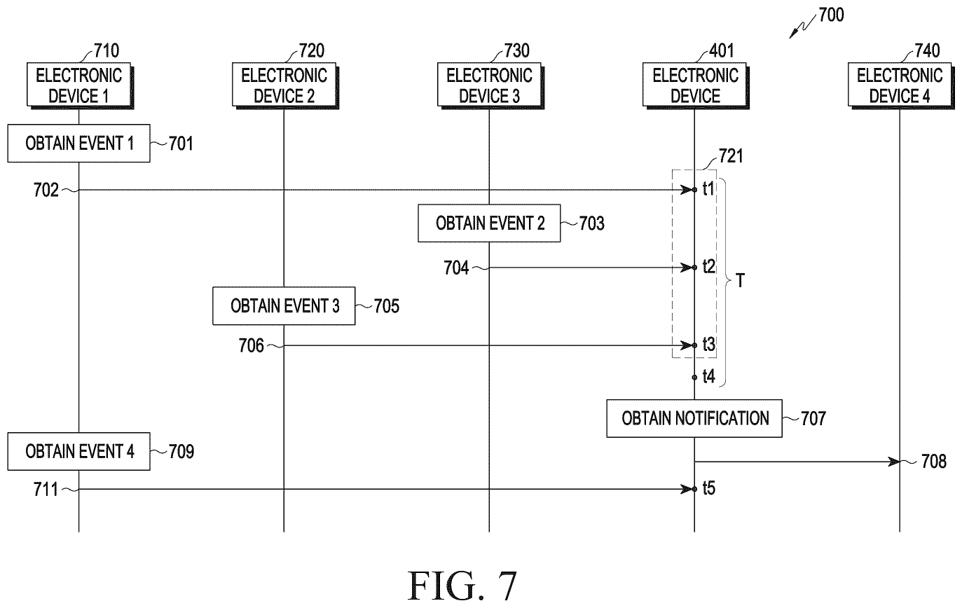

FIG. 7 is a view illustrating a method for providing a notification according to an embodiment of the disclosure.

FIG. 7 may be a view 700 illustrating a method of providing a notification corresponding to at least one group obtained based on the location (e.g., home, company) registered in the electronic device 401 (e.g., the central device).

Referring to FIG. 7, an electronic device 1 710, electronic device 2 720, and electronic device 3 730, respectively, may represent electronic devices (e.g., one or more first electronic devices 311, 312, and 313 of FIGS. 3A and 3B) capable of generating an event related to intrusion detection. Electronic device 1 710, electronic device 2 720, and electronic device 3 730 may be, e.g., electronic devices registered in the electronic device 401 (e.g., the central device) in association with a home. In FIG. 7, the electronic device 401 may represent a central electronic device, and electronic device 4 740 may represent an electronic device (e.g., the second electronic device 330 of FIGS. 3A and 3B) that receives a notification.

In operation 701, electronic device 1 710 may obtain (e.g., generate) event 1. For example, electronic device 1 710 may obtain event 1 related to intrusion by detecting intrusion by a person (or an object) in a registered location.

In operation 702, electronic device 1 710 may transmit the obtained event 1 to the electronic device 401 (e.g., the central device).

When event 1 is received from electronic device 1 710, the electronic device 401 may identify the time t1 of reception of event 1, and may identify that electronic device 1 710 is registered in association with the home. The electronic device 401 may wait for a designated time T from the time t1 of reception of event 1 (e.g., for a time from the time t1 of reception of event 1 to a time t4 after the designated time T). For example, when event 1 is received from electronic device 1 710, the electronic device 401 may not transmit a notification related to event 1 to electronic device 4 740 for the designated time T.

In operation 703, electronic device 3 730 may obtain event 2.

In operation 704, electronic device 3 730 may transmit the obtained event 2 to the electronic device 401. In an embodiment, the time when the electronic device 401 receives event 2 may be a time t2 within the designated time T with respect to the time t1 of reception of event 1.

In operation 705, electronic device 2 720 may obtain event 3.

In operation 706, electronic device 2 720 may transmit the obtained event 3 to the electronic device 401. In an embodiment, the time when the electronic device 401 receives event 3 may be a time t3 within the designated time T with respect to the time t1 of reception of event 1.

In operation 707, the electronic device 401 may obtain a group 721 including event 1, event 2, and event 3, which are received within the designated time T with respect to the time t1 of reception of event 1. The processor 430 may obtain a notification corresponding to the obtained group 721 based on event 1, event 2, and event 3.

In operation 708, the processor 430 may transmit the obtained notification to electronic device 4 740. Although not illustrated in FIG. 7, when a notification is received from the electronic device 401, electronic device 4 740 may output the received notification.

In operation 709, electronic device 1 710 may obtain event 4.

In operation 711, electronic device 1 710 may transmit the obtained event 4 to the electronic device 401. In an embodiment, the time when the electronic device 401 receives event 4 may be the time 15, which is an arbitrary time after the designated time T elapses with respect to the time t1 of reception of event 1. According to an embodiment of the disclosure, although not illustrated in FIG. 7, the processor 430 may wait for the designated time T with respect to the time t5 of reception of event 4 in order to obtain a group different from the group 721 obtained in operation 707.

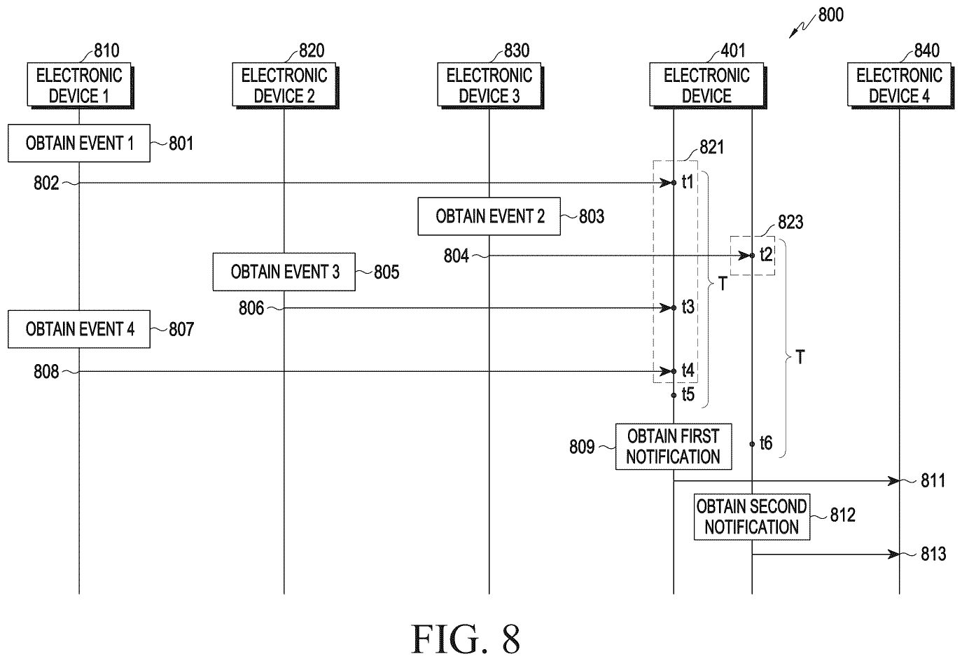

FIG. 8 is a view illustrating a method for providing a notification according to an embodiment of the disclosure.

FIG. 8 may be a view 800 illustrating a method of providing a notification corresponding to at least one group obtained based on the room (e.g., room 1, room 2) registered in the electronic device 401 (e.g., the central device).

Referring to FIG. 8, electronic device 1 810, electronic device 2 820, and electronic device 3 830, respectively, may represent electronic devices (e.g., one or more first electronic devices 311, 312, and 313 of FIGS. 3A and 3B) capable of generating an event related to intrusion detection. Electronic device 1 810 and electronic device 2 820 may be, e.g., electronic devices registered in the electronic device 401 (e.g., the central device) in association with room 1, and electronic device 3 830 may be an electronic device registered in the electronic device 401 in association with room 2. In FIG. 8, the electronic device 401 may represent a central electronic device, and electronic device 4 840 may represent an electronic device (e.g., the second electronic device 330 of FIGS. 3A and 3B) that receives a notification.

In operation 801, electronic device 1 810 may obtain (e.g., generate) event 1. For example, electronic device 1 810 may obtain event 1 related to intrusion by detecting intrusion by a person (or an object) in a registered location.

In operation 802, electronic device 1 810 may transmit the obtained event 1 to the electronic device 401 (e.g., the central device).

When event 1 is received from electronic device 1 810, the electronic device 401 may identify the time t1 of reception of event 1, and may identify that electronic device 1 810 is registered in association with room 1. The processor 430 may wait for a designated time T from the time t1 of reception of event 1 (e.g., for a time from the time t1 of reception of event 1 to the time t5 after the designated time T). For example, when event 1 is received from electronic device 1 810, the electronic device 401 may not transmit a notification related to event 1 to electronic device 4 840 for the designated time T.

In operation 803, electronic device 3 830 may obtain event 2.

In operation 804, electronic device 3 830 may transmit the obtained event 2 to the electronic device 401.

When event 2 is received from electronic device 3 830, the electronic device 401 may identify the time t2 of reception of event 2, and may identify that electronic device 3 830 is registered in association with room 2. The processor 430 may wait for the designated time T from the time t2 of reception of event 2 (e.g., for a time from the time t2 of reception of event 2 to the time to after the designated time T). For example, when event 2 is received from electronic device 3 830, the electronic device 401 may not transmit a notification related to event 2 to electronic device 4 840 for the designated time T.

In operation 805, electronic device 2 820 may obtain event 3.

In operation 806, electronic device 2 820 may transmit the obtained event 3 to the electronic device 401.

The electronic device 401 may identify that electronic device 2 820 is registered in the electronic device 401 in association with room 1, like electronic device 1 810. The time when the electronic device 401 receives event 3 may be a time t3 within the designated time T with respect to the time t1 of reception of event 1 related to room 1.

In operation 807, electronic device 1 810 may obtain event 4.

In operation 808, electronic device 1 810 may transmit the obtained event 4 to the electronic device 401.

The time when the electronic device 401 receives event 4 may be a time 14 within the designated time T with respect to the time t1 of reception of event 1 related to room 1.

In operation 809, the electronic device 401 may obtain a first group 821 including event 1, event 3, and event 4, which are received within the designated time T with respect to the time t1 of reception of event 1 and are related to room 1. The processor 430 may obtain a first notification corresponding to the obtained first group 821 based on event 1, event 3, and event 4.

In operation 811, the processor 430 may transmit the obtained first notification to electronic device 4 840. Although not illustrated in FIG. 8, when the first notification is received from the electronic device, electronic device 4 840 may output the received first notification.

In operation 812, the electronic device 401 may obtain a second group 823 including event 2, which is received within the designated time T with respect to the time t2 of reception of event 2 and is related to room 2. The processor 430 may obtain a second notification corresponding to the obtained second group 823 based on event 2.

In operation 813, the processor 430 may transmit the obtained second notification to electronic device 4 840. Although not illustrated in FIG. 8, when the second notification is received from the electronic device 401, electronic device 4 840 may output the received second notification.

FIGS. 9A to 9C are views illustrating a method for obtaining a group based on an intrusion detection range of one or more first electronic devices according to various embodiments of the disclosure.

Referring to FIGS. 9A to 9C, in FIG. 9A, an electronic device P1 may be a central device, and electronic device 1 D1 and electronic device 2 D2 may be electronic devices (e.g., the one or more first electronic devices 311, 312, and 313 of FIGS. 3A and 3B) registered in the electronic device P1 and capable of obtaining an event.

The electronic device P1 may be connected using communication (e.g., UWB communication) with electronic device 1 D1 and electronic device 2 D2. The electronic device P1 may receive, from electronic device 1 D1, a distance (e.g., a radius r1 with respect to the location of electronic device 1 D1) where electronic device 1 D1 may detect an intrusion (or a range) using communication. The distance where electronic device 1 D1 may detect an intrusion may be a distance where electronic device 1 D1 may obtain (e.g., detect an intrusion) an event related to the intrusion. The electronic device P1 may receive a distance (e.g., a radius r2 with respect to the location of electronic device 2 D2) where electronic device 2 D2 may detect an intrusion from electronic device 2 D2 using communication.

The electronic device P1 may obtain the distance 11 between electronic device 1 D1 and the electronic device and the direction of the electronic device with respect to electronic device 1 D1, the distance 12 between electronic device 2 D2 and electronic device, and the direction of the electronic device with respect to electronic device 2 D2 using communication (e.g., UWB communication) with electronic device 1 D1 and electronic device 2 D2. In an embodiment, the electronic device P1 may obtain the distance r between electronic device 1 D1 and electronic device 2 D2, based on the distance 11 between electronic device 1 D1 and the electronic device, the direction of the electronic device with respect to electronic device 1 D1, the distance 12 between electronic device 2 D2 and the electronic device, and the direction of the electronic device with respect to electronic device 2 D2.

Based on the distance (e.g., the radius r1) where electronic device 1 D1 may detect intrusion, the distance (e.g., the radius r2) where electronic device 2 D2 may detect intrusion, and the distance r between electronic device 1 D1 and electronic device 2 D2, the electronic device P1 may identify whether there is an overlapping area (e.g., area g1) in which a range (e.g., a range within the radius r1 with respect to the location of electronic device 1 D1) where electronic device 1 D1 may detect intrusion and a range (e.g., a range within the radius r2 with respect to the location of electronic device 2 D2) where electronic device 2 D2 may detect intrusion.

In the illustrated in FIG. 9A, when there is an overlapping area between the range in which electronic device 1 D1 may detect the intrusion and the range in which electronic device 2 D2 may detect the intrusion, the electronic device P1 may include the event received from electronic device 1 D1 and the event received from electronic device 2 D2 in the same group (e.g., one group). For example, when the electronic device P1 receives event 1 from electronic device 1 D1 and receives event 2 from electronic device 2 D2 within the designated time from the time when the electronic device P1 receives event 1, the electronic device P1 may obtain (e.g., generate) a group including event 1 and event 2.

The electronic device P1 may classify events received from electronic devices having the overlapping area between the ranges capable of detecting intrusion, among electronic devices (e.g., the one or more first electronic devices 311, 312, and 313 of FIGS. 3A and 3B) registered in the electronic device P1, into the same group. For example, in FIG. 9B, the distances between the electronic device P1 and electronic device 1 D1, electronic device 2 D2, and electronic device 3 D3 may be the distance 11, the distance 12, and the distance 13, respectively. The electronic device P1 may identify the distances between electronic device 1 D1, electronic device 2 D2, and electronic device 3 D3, based on the distance 11 (and the direction of the electronic device P1 with respect to electronic device 1 D1), the distance 12 (and the direction of the electronic device P1 with respect to electronic device 2 D2), and the distance 13 (and the direction of the electronic device P1 with respect to electronic device 3 D3). Based on the identified distances, the range in which electronic device 1 D1 may detect an intrusion, the range in which electronic device 2 D2 may detect an intrusion, and the range in which electronic device 3 D3 may detect an intrusion, the electronic device P1 may detect whether there are overlapping areas (e.g., area g1, area g2, and area g3) between ranges in which electronic device 1 D1, electronic device 2 D2, and electronic device 3 D3 may detect intrusion (e.g., a range within a radius r1 with respect to the location of electronic device 1 D1, a range within a radius r2 with respect to the location of electronic device 2 D2, and a range within a radius r3 with respect to the location of electronic device 3 D3). In this case, the electronic device P1 may classify the events received from electronic device 1 D1, electronic device 2 D2, and electronic device 3 D3 into one first group. In FIG. 9B, the distances between the electronic device P1 and electronic device 4 D4, electronic device 5 D5, and electronic device 6 D6 may be the distance 14, the distance 15, and the distance 16, respectively. The electronic device P1 may identify the distances between electronic device 4 D4, electronic device 5 D5, and electronic device 6 D6 based on the distance 14 (and the direction of the electronic device P1 with respect to electronic device 4 D4), the distance 15 (and the direction of the electronic device P1 with respect to electronic device 5 D5), and the distance 16 (and the direction of the electronic device P1 with respect to electronic device 6 D6). Based on the identified distances, the range in which electronic device 4 D4 may detect an intrusion, the range in which electronic device 5 D5 may detect an intrusion, and the range in which electronic device 6 D6 may detect an intrusion, the electronic device P1 may detect whether there are overlapping areas (e.g., area g5 and area g6) between ranges in which electronic device 4 D4, electronic device 5 D5, and electronic device 6 D6 may detect intrusion (e.g., a range within a radius r4 with respect to the location of electronic device 4 D4, a range within a radius r5 with respect to the location of electronic device 5 D5, and a range within a radius r6 with respect to the location of electronic device 6 D6). In FIG. 9B, the ranges in which electronic device 1 D1, electronic device 2 D2, and electronic device 3 D3 may detect intrusion and the ranges in which electronic device 4 D4, electronic device 5 D5, and electronic device 6 D6 may detect intrusion may not overlap each other. In this case, the electronic device P1 may classify events received from electronic device 4 D4, electronic device 5 D5, and electronic device 6 D6 into one second group different from the first group.

In the above-described examples, a method of classifying events received from electronic devices (e.g., the one or more first electronic devices 311, 312, and 313 of FIGS. 3A and 3B) registered in the electronic device P1 into at least one group has been described, but the disclosure is not limited thereto.

The electronic device P1 may obtain at least one device group (hereinafter, the group into which the electronic devices registered in the electronic device P1 are classified is referred to as a “device group”) by classifying the electronic devices registered in the electronic device P1 based on the distance where each of the electronic devices registered in the electronic device P1 may detect an intrusion, and the distance between the electronic device P1 and each of the electronic devices registered in the electronic device P1 (and the direction of the electronic device P1 with respect to each of the electronic devices registered in the electronic device P1) before receiving the event from the electronic devices registered in the electronic device P1 (e.g., whenever each of the electronic devices is registered in the electronic device). For example, in FIG. 9B, through the above-described operations, the electronic device P1 may classify electronic device 1 D1, electronic device 2 D2, and electronic device 3 D3 as device group 1, and may classify electronic device 4 D4, electronic device 5 D5, and electronic device 6 D6 as device group 2 different from device group 1. The electronic device P1 may register information about the device group 1 and information about the device group 2. After the device group 1 and the device group 2 are registered, when event 1 is received from electronic device 1 D1 included in the device group 1, and event 2 is received from electronic device 2 D2 within the designated time with respect to the time of reception of event 1, the electronic device P1 may classify event 1 and event 2 into one first group. After the device group 1 and the device group 2 are registered, even when event 1 is received from electronic device 1 D1 included in the device group 1, and event 4 is received from electronic device 4 D4 included in the device group 2 within the designated time with respect to the time of reception of event 1, the electronic device P1 may classify event 1 and event 2 into different groups. After the device group 1 and the device group 2 are registered, when event 1 is received from electronic device 1 D1 included in the device group 1, and event 2 is received from electronic device 2 D2 after the designated time with respect to the time of reception of event 1, the electronic device P1 may classify event 1 and event 2 into different groups.

The electronic device P1 may maintain or update the electronic devices registered in the electronic device P1 in at least one device group by obtaining (e.g., measuring) the distance where each of the electronic devices registered in the electronic device P1 may detect an intrusion, and the distance between the electronic device P1 and each of the electronic devices registered in the electronic device P1 (and the direction of the electronic device with respect to each of the electronic devices registered in the electronic device), periodically, before receiving the event from the electronic devices registered in the electronic device P1.

When the number of electronic devices included in the device group is equal to or larger than a designated number, the electronic device P1 may newly obtain at least one device group, based on a reduced intrusion detection distance, by multiplying the distance (or range) where each of the electronic devices may detect intrusion by a designated ratio.

For example, in reference numeral 903 of FIG. 9C, intrusion detection distances (e.g., actual intrusion detection distances) of electronic device 1 D1, electronic device 2 D2, electronic device 3 D3, electronic device 4 (D4), electronic device 5 D5, and electronic device 6 D6 may be r11, r21, r31, r41, r51, and r61, respectively. Since the intrusion detection ranges determined by the intrusion detection distances of electronic device 1 D1, electronic device 2 D2, electronic device 3 D3, electronic device 4 D4, electronic device 5 D5, and electronic device 6 D6 have overlapping areas, electronic device 1 D1, electronic device 2 D2, electronic device 3 D3, electronic device 4 (D4), electronic device 5 D5, and electronic device 6 D6 may be classified into one device group 1. For example, when the number of the electronic devices included in the device group 1 is six or more as the designated number, as shown in reference numeral 904 of FIG. 9C, the electronic device P1 may calculate the reduced intrusion detection distances r12, r22, r32, r42, r52, and r62 of electronic device 1 D1, electronic device 2 D2, electronic device 3 D3, electronic device 4 D4, electronic device 5 D5, and electronic device 6 D6 by multiplying each of the intrusion detection distances r11, r21, r31, r41, r51, and r61 of electronic device 1 D1, electronic device 2 D2, electronic device 3 D3, electronic device 4 D4, electronic device 5 D5, and electronic device 6 D6 by the designated ratio. The electronic device P1 may identify overlapping areas between the reduced intrusion detection ranges determined by the reduced intrusion detection distances, based on the reduced intrusion detection distances r12, r22, r32, r42, r52, and r62. The electronic device P1 may obtain the device group 2 including electronic device 1 and the electronic device 2, and may obtain the device group 3 including the electronic device 3, the electronic device 4, the electronic device 5, and the electronic device 6, based on the identified overlapping areas.

FIG. 10 is a view illustrating a method for obtaining a group based on a distance between one or more first electronic devices according to an embodiment of the disclosure.

Referring to FIG. 10, the electronic device P1 may be a central device, and electronic device 1 D1 and electronic device 2 D2 may be electronic devices (e.g., the one or more first electronic devices 311, 312, and 313 of FIGS. 3A and 3B) registered in the electronic device P1 and capable of obtaining an event.

The electronic device P1 may obtain at least one group based on the distance between the electronic devices (e.g., electronic device 1 D1 and electronic device 2 D2). For example, the electronic device P1 may be connected using communication (e.g., UWB communication) with electronic device 1 D1 and electronic device 2 D2. The electronic device P1 may obtain the distance 11 between electronic device 1 D1 and the electronic device P1, the direction of the electronic device P1 with respect to electronic device 1 D1, the distance 12 between electronic device 2 D2 and the electronic device P1, and the direction of the electronic device P1 with respect to electronic device 2 D2 using communication (e.g., UWB communication) between electronic device 1 D1 and electronic device 2 D2. The electronic device P1 may obtain (e.g., calculate) the distance between electronic device 1 D1 and electronic device 2 D2, based on the distance 11 between electronic device 1 D1 and the electronic device, the direction of the electronic device P1 with respect to electronic device 1 D1, the distance 12 between electronic device 2 D2 and the electronic device, and the direction of the electronic device P1 with respect to electronic device 2 D2. When the distance r between electronic device 1 D1 and electronic device 2 D2 is less than the designated distance and the electronic device P1 receives event 2 from electronic device 2 D2 within the designated time from the time of reception of event 1 received from electronic device 1 D1, the electronic device P1 may classify event 1 and event 2 into one group (e.g., may include event 1 and event 2 in one group). When the distance r between electronic device 1 D1 and electronic device 2 D2 is less than the designated distance and the electronic device P1 receives event 2 from electronic device 2 D2 after the designated time elapses from the time of reception of event 1 received from electronic device 1 D1, the electronic device P1 may classify event 1 and event 2 into different groups. Even if the distance r between electronic device 1 D1 and electronic device 2 D2 is larger than or equal to the designated distance and the electronic device P1 receives event 2 from electronic device 2 D2 within the designated time from the time of reception of event 1 received from electronic device 1 D1, the electronic device P1 may classify event 1 and event 2 into different groups.

The electronic device P1 may obtain at least one device group based on the distance between the electronic devices (e.g., electronic device 1 D1 and electronic device 2 D2). For example, when the distance between electronic device 1 D1 and electronic device 2 D2 is less than the designated distance, the electronic device P1 may classify electronic device 1 D1 and electronic device 2 D2 into the same group. As another example, when the distance between electronic device 1 D1 and electronic device 2 D2 is larger than or equal to the designated distance, the electronic device P1 may classify electronic device 1 D1 and electronic device 2 D2 into different groups.

The electronic device P1 may maintain or update at least one device group by periodically obtaining (e.g., measuring) the distance between electronic devices (e.g., electronic device 1 D1 and electronic device 2 D2).

When the number of electronic devices included in the device group is equal to or larger than a designated number, the electronic device P1 may newly obtain at least one device group, based on a reduced intrusion detection distance, by multiplying the distance between the electronic devices by a designated ratio.

FIG. 11 is a flowchart illustrating a method for providing a notification based on settings related to the notification according to an embodiment of the disclosure.

Referring to FIG. 11, the illustrated flowchart 1100 is merely an embodiment, and the operation order according to various embodiments of the disclosure may be different from that illustrated in FIG. 11, and some of the operations illustrated in FIG. 11 may be omitted, the order between the operations may be changed, or the operations may be merged.

Referring to FIG. 11, in operation 1101, the processor 430 may receive one or more events from one or more first electronic devices (e.g., the one or more first electronic devices 311, 312, and 313 of FIGS. 3A and 3B) through the communication module 410. Operation 1101 is at least partially identical or similar to operation 601 of FIG. 6, and thus a detailed description thereof is omitted.

In operation 1103, in an embodiment, the processor 430 may obtain at least one group for the one or more events, based on the times of reception of the one or more events received from the one or more first electronic devices. Operation 1103 is at least partially identical or similar to operation 603 of FIG. 6, and thus a detailed description thereof is omitted.

In operation 1105, the processor 430 may obtain a notification corresponding to at least one group. Since operation 1105 is at least partially the same as or similar to operation 605 of FIG. 6, a detailed description thereof will be omitted.

In operation 1107, the processor 430 may determine whether to transmit a notification, based on a setting related to the notification.

The setting related to the notification may include a setting for determining whether to transmit the notification obtained through operation 1105 to the user's electronic device (e.g., the second electronic device of FIGS. 3A and 3B).

The setting related to the notification may include a setting (e.g., a setting about turning on/off the notification reception function) for whether the electronic device (e.g., the second electronic device 330) of the user receives the notification and/or a setting about a time interval in which the notification is not received. For example, the electronic device of the user may set whether the electronic device of the user receives a notification from the electronic device 401 (e.g., the central device), based on a user input. As another example, the electronic device of the user may make a setting related to the notification so that the notification is not received in a specific time interval (e.g., 9 a.m. to 12 a.m.) and the notification is received in a time interval other than the specific time interval, based on the user input. If the setting related to the notification is made, the electronic device of the user may transmit the setting related to the notification to the electronic device 401 (e.g., the central device) so that the electronic device 401 (e.g., the central device) determines whether to transmit the notification to the electronic device of the user based on the setting related to the notification.

The setting related to the notification may be made for each location and/or room registered in the electronic device 401 (e.g., the central device). For example, the setting related to the notification may be made so as to receive a notification for room 1 and not to receive a notification for room 2. As another example, the setting related to the notification may be made so that the notification is not received in the first time interval for room 1 and the notification is not received in the second time interval for room 2.

The setting related to the notification may be set differently according to the location and/or room where the electronic device of the user (or the user) is registered in the electronic device 401 (e.g., the central device). For example, when the electronic device of the user is positioned in the home registered in the electronic device 401 (e.g., the central device), a setting related to the notification may be made so as not to receive the notification. As another example, when the electronic device of the user is not positioned in the home registered in the electronic device 401 (e.g., the central device) (e.g., when the user is positioned outside the home), a setting related to the notification may be made to receive the notification.

The setting related to the notification may be made differently according to whether the electronic device of the member invited to the service providing the notification (or the invited member) is positioned in the room and/or the location registered in the electronic device 401 (e.g., the central device). The electronic device of the member invited to the notification providing service may refer to an electronic device to which at least the portion of the authority to use the notification providing service is granted by the electronic device of the user, using the account of the user. For example, the electronic device of the member invited to the notification providing service may refer to an electronic device capable of receiving the notification from the electronic device 401 (e.g., the central device) together with the electronic device of the user.

When the processor 430 determines to transmit the notification in operation 1107, the processor 430 may transmit the notification to the second electronic device (e.g., the second electronic device 330) through the communication module 410 in operation 1109. Operation 1109 is at least partially identical or similar to operation 607 of FIG. 6, and thus a detailed description thereof is omitted.

When the processor 430 determines not to transmit the notification in operation 1107, the processor 430 may not transmit the notification to the second electronic device (e.g., the second electronic device 330).

FIG. 12 is a flowchart illustrating a method for providing a notification based on the level of the notification according to an embodiment of the disclosure.

Referring to FIG. 12, the illustrated flowchart 1200 is merely an embodiment, and the operation order according to various embodiments of the disclosure may be different from that illustrated in FIG. 12, and some of the operations illustrated in FIG. 12 may be omitted, the order between the operations may be changed, or the operations may be merged.

Referring to FIG. 12, in operation 1201, the processor 430 may receive one or more events from one or more first electronic devices (e.g., the one or more first electronic devices 311, 312, and 313 of FIGS. 3A and 3B) through the communication module 410. Operation 1201 is at least partially identical or similar to operation 601 of FIG. 6, and thus a detailed description thereof is omitted.

In operation 1203, the processor 430 may obtain at least one group for the one or more events, based on the times of reception of the one or more events received from the one or more first electronic devices. Operation 1203 is at least partially identical or similar to operation 603 of FIG. 6, and thus a detailed description thereof is omitted.

In operation 1205, the processor 430 may obtain a notification corresponding to at least one group. Since operation 1205 is at least partially the same as or similar to operation 605 of FIG. 6, a detailed description thereof will be omitted.

In operation 1207, The processor 430 may determine the level of the notification.

The level of the notification may be a level related to the degree of risk of intrusion. For example, as the level of the notification increases, the probability of intrusion into the electronic device 401 (e.g., the central device) may increase.

The processor 430 may determine the level of the notification based on at least one of the capability of the electronic devices (e.g., the one or more first electronic devices 311, 312, and 313 of FIGS. 3A and 3B) registered in the electronic device 401 (e.g., the central device) and transmitting an event (e.g., the function (or type) for intrusion detection of each of the registered electronic devices), the type of the event received from the registered electronic devices, the probability of malfunction of the registered electronic devices (or the electronic devices registered and transmitting the event) (e.g., the probability of failing to accurately measure whether there is intrusion), the sensibility set for the registered electronic devices (or the electronic devices registered and transmitting the event), whether the electronic devices are registered, whether the event is received from all of the registered electronic devices in association with the registered location and/or room, or the number of the electronic devices registered in association with the registered location and/or room and transmitting the event.

For example, the processor 430 may determine (e.g., assign) a higher level than the notification obtained based on the event received from a sound detection sensor having the capability of detecting the sound and notification obtained based on the event received from the motion sensor having the capability of detecting movement for the notification obtained based on the event received from the door lock or door open sensor having the capability (or function) of detecting door opening and/or contact for detecting the intruder's action for the device.

As another example, the processor 430 may determine a level higher than the level of the notification obtained based on the event related to the movement, for the notification obtained based on the event related to the contact and/or door opening. The processor 430 may determine a higher level than the notification obtained based on the event related to the sound, for the notification obtained based on the event related to the movement providing more information than the sound in relation to the intrusion.

As another example, the processor 430 may determine a higher level of the notification obtained based on the event received from the door lock or the door open sensor having a low malfunction probability (e.g., high accuracy of measuring intrusion) than the notification obtained based on the event received from the sound detection sensor having a high malfunction probability.

As another example, the processor 430 may determine a higher level than a reference level, for the notification obtained based on the event received from the electronic device configured to have low sensibility. The processor 430 may determine a lower level than the reference level, for the notification obtained based on the event received from the electronic device configured to have high sensibility. In an embodiment, the sensibility may be a threshold size of sensing data which serves as a reference for determining whether the registered electronic device generates an event. For example, when lower sensibility is set in the registered electronic device, the registered electronic device may generate an event in response to a small movement (or a small change in movement) or a small sound. In an embodiment, the processor 430 may determine the level of the notification based on a representative value (e.g., maximum value, minimum value, least frequent value, intermediate value, or average value) of sensibility set in the electronic devices transmitting the event.

As another example, when the motion sensor is registered in association with room 1, the processor 430 may determine a higher level than the notification obtained based on the event received from the electronic device registered in association with room 2 with which the motion sensor is not registered in association, for the notification obtained based on the event received from the electronic device registered in association with room 1.

As another example, the processor 430 may determine a higher level than the notification obtained based on the event received from some of the electronic devices registered in association with registered room 1, for the notification obtained based on the event received from all of the electronic devices registered in association with registered room 1.

As another example, the processor 430 may determine a higher level than the notification obtained based on the event received from four electronic devices registered in association with registered room 1, for the notification obtained based on the event received from five electronic devices registered in association with registered room 1.

The processor 430 may assign priorities (or weights) to at least one of the capability (or type) of the electronic devices transmitting the event and registered in the electronic device 401 (e.g., the central device), the type of the event received from the registered electronic devices, the probability of malfunction of the registered electronic devices, the sensibility set for the registered electronic devices, whether the electronic devices are registered, whether the event is received from all of the electronic devices registered in association with the registration location and/or room, or at least one of the number of electronic devices transmitting the event and registered in association with the registered location and/or room. The processor 430 may determine the level of the notification based on the assigned priorities (or weights). For example, the processor 430 may assign a higher priority (or a higher weight) in the order of the capability (or type) of the electronic devices registered in the electronic device 401 (e.g., the central device) and transmitting the event, the type of the event received from the registered electronic devices, and the probability of malfunction of the registered electronic devices. The processor 430 may determine the level of the notification based on the priorities (or weights).

The processor 430 may determine the final level of the notification by determining the level of the notification and then adjusting the determined level of the notification. For example, it may be assumed that the door lock, the door open sensor, the motion sensor, and the sound detection sensor are registered in the electronic device 401 (e.g., the central device). It may be assumed that the level of the notification includes level 1, level 2, and level 3, and the level is higher in the order of level 3, level 2, and level 1. The processor 430 may determine the higher level in the order of the notification corresponding to the group including event 1 received from the door lock and the door open sensor, the notification corresponding to the group including event 2 received from the motion sensor, and the notification corresponding to the group including event 3 received from the sound detection sensor, based on the capability of the door lock, door open sensor, motion sensor, and sound detection sensor, the type of the events transmitted by the door lock, door open sensor, motion sensor, and sound detection sensor, and the probability of malfunction of the door lock, door open sensor, motion sensor, and sound detection sensor. In an embodiment, when the group includes an event related to the door opening/closing of the door lock or door open sensor, the processor 430 may determine the level of the group as level 2. When the group includes an event received from a motion sensor, when the group includes events received from two or more motion sensors, when the group includes an event received from a motion sensor and an event received a sound detection sensor, when the group includes an event related to the movement of a person from a motion sensor having the capability of detecting an object movement or a person movement, when the group includes an event from an electronic device set to have lower sensibility, and/or when the group includes events received from all of the electronic devices registered in association with the registered location and/or room (hereinafter, referred to as “when a level up condition is met”), the processor 430 may adjust the level (e.g., level 2) of the notification corresponding to the group to a higher level (e.g., level 3). When the group does not include an event other than the event related to the door opening/closing of the door lock or door open sensor, when the sensibility of the door lock and/or door open sensor setting an event is set to be higher (hereinafter, referred to as “when a level down condition is met”), the processor 430 may adjust the level (e.g., level 2) of the notification corresponding to the group to a lower level (e.g., level 1).

Table 1 below illustrates examples of the notification level corresponding to the group based on whether the group including the event related to the door opening/closing of the door lock or door open sensor includes an event received from the motion sensor and/or the sound detection sensor and whether the motion sensor and/or sound detection sensor is registered for the room corresponding to the group (e.g., when the group is obtained based on the times of reception of the event and the room, the room related to the group).

TABLE 1

| | | When motion sensor is registered | | |
|---|---|---|---|---|
| | | When event | When event | |
| | | related to | related to | |
| | | movement is | movement is not | When motion |
| | | received from | received from | sensor is not |
| | | motion sensor | motion sensor | registered |
| When sound | When event | level 3 | level 1 | level 1 |
| detection | related to sound | | | |
| sensor is | is received from | | | |
| registered | sound detection | | | |
| | sensor | | | |
| | When event | level 2 or level 3 | level 1 | level 1 |
| | related to sound | | | |
| | is not received | | | |
| | from sound | | | |
| | detection sensor | | | |

| | | | |
|---|---|---|---|
| When sound detection sensor is | level 2 or level 3 | level 1 | level 2 |
| not registered | | | |

Referring to Table 1, when the group including the event related to the door opening/closing of the door lock or door open sensor includes the event related to movement and the event related to sound respectively received from the motion sensor and the sound detection sensor registered for the room corresponding to the group (e.g., in Table 1, when the event related to movement is received from the motion sensor and the event related to sound is received from the sound detection sensor), the processor 430 may determine the level of notification corresponding to the group as level 3.

Referring to Table 1, when the group including the event related to the door opening/closing of the door lock or door open sensor includes the movement-related event received from the motion sensor registered for the room corresponding to the group and the sound detection sensor is registered for the room corresponding to the group, but the group does not receive the event related to the sound from the sound detection sensor (e.g., in Table 1, when the movement-related event is received from the motion sensor and the sound-related event is not received from the sound detection sensor), the processor 430 may determine the level of the notification corresponding to the group as level 2 or level 3.

Referring to Table 1, when the group including the event related to the door opening/closing of the door lock or door open sensor includes the movement-related event received from the motion sensor registered for the room corresponding to the group and the sound detection sensor is not registered for the room corresponding to the group (e.g., in Table 1, when the movement-related event is received from the motion sensor, and when the sound detection sensor is not registered), the processor 430 may determine the level of the notification corresponding to the group as level 2 or level 3.

Referring to Table 1, when the group including the event related to the door opening/closing of the door lock or door open sensor includes the sound-related event received from the sound detection sensor registered for the room corresponding to the group, and the motion sensor is registered for the room corresponding to the group, but the movement-related event is not received from the motion sensor (e.g., in Table 1, when the sound-related event is received from the sound detection sensor and when the movement-related event is not received from the motion sensor), the processor 430 may determine the level of the notification corresponding to the group as level 1.

Referring to Table 1, in relation to the group including the event related to the door opening/closing of the door lock or door open sensor, when the sound detection sensor and motion sensor are registered for the room corresponding to the group but the sound-related event and movement-related event are not received from the sound detection sensor and the motion sensor (e.g., in Table 1, when the sound-related event is not received from the sound detection sensor and when the movement-related event is not received from the motion sensor), the processor 430 may determine the level of the notification corresponding to the group as level 1.

Referring to Table 1, in relation to the group including the event related to the door opening/closing of the door lock or door open sensor, when the sound detection sensor is not registered for the room corresponding to the group, and the motion sensor is registered for the room corresponding to the group but the movement-related event is not received from the motion sensor (e.g., in Table 1, when the sound detection sensor is not registered and when the movement-related event is not received from the motion sensor), the processor 430 may determine the level of the notification corresponding to the group as level 1.

Referring to Table 1, when the group including the event related to the door opening/closing of the door lock or door open sensor includes the sound-related event received from the sound detection sensor registered for the room corresponding to the group, and the motion sensor is not registered for the room corresponding to the group (e.g., in Table 1, when the sound-related event is received from the sound detection sensor and when the motion sensor is not registered), the processor 430 may determine the level of the notification corresponding to the group as level 1.

Referring to Table 1, in relation to the group including the event related to the door opening/closing of the door lock or door open sensor, when the sound detection sensor is registered for the room corresponding to the group, but the sound-related event is not received from the sound detection sensor, and the motion sensor is not registered for the room corresponding to the group (e.g., in Table 1, when the sound-related event is not received from the sound detection sensor and when the motion sensor is not registered), the processor 430 may determine the level of the notification corresponding to the group as level 1.

Referring to Table 1, in relation to the group including the event related to the door opening/closing of the door lock or door open sensor, when the motion detection sensor and the sound detection sensor are not registered for the room corresponding to the group, the processor 430 may determine the level of the notification corresponding to the group as level 2.

When the group includes the movement-related event of the motion sensor without including the event related to the door opening/closing of the door lock or door open sensor, the processor 430 may determine the level of the notification corresponding to the group as level 2. The processor 430 may adjust the level (e.g., level 2) of the notification corresponding to the group to be higher or lower based on the representative value (e.g., maximum value, minimum value, least frequent value, intermediate value, or average value) of the sensibilities of the electronic devices transmitting the event including the group, whether the above-described level up condition is met, and whether the above-described level down condition is met.

When the group includes only the sound detection sensor-related event, the probability of malfunction is high by the nature of the sound detection sensor, and less information is provided than other electronic devices in relation to intrusion, the processor 430 may determine the level of the notification corresponding to the group as level 1 (e.g., the lowest level among level 1 to level 3). The processor 430 may adjust the determined notification level to a level (e.g., level 2) higher than the determined notification level based on the representative value of the sensibilities of the electronic devices transmitting the event included in the group and/or whether the above-described level up condition is met.

The processor 430 may determine the level for each of a plurality of notifications when the plurality of notifications are obtained through operation 1207.

In operation 1209, the processor 430 may determine whether the level of the notification is larger than or equal to a designated level.

The designated level may be a designated level for determining whether the electronic device 401 (e.g., the central device) is to transmit a notification to the user's electronic device (e.g., the second electronic device of FIGS. 3A and 3B). The designated level may be designated as a default level or may be designated by the user.

When it is determined that the level of the notification is larger than or equal to the designated level in operation 1209, the processor 430 may transmit the notification to the electronic device of the user through the communication module 410 in operation 1211.

When it is determined that the level of the notification is less than the designated level in operation 1209, the processor 430 may not transmit the notification to the electronic device of the user. For example, the processor 430 may not transmit the notification to the user's electronic device in real time. In this case, when the processor 430 receives a request for a notification (e.g., a notification in which the level of the notification is less than the designated level) that has not been transmitted from the electronic device of the user based on a user input, the processor 430 may transmit the notification that has not been transmitted from the electronic device of the user through the communication module 410.

FIG. 12 illustrates that the processor 430 does not transmit a notification having a level less than the designated level to the electronic device of the user when the level of the notification is less than the designated level, but embodiments of the disclosure are not limited thereto. For example, even when the level of the notification is less than the designated level, the processor 430 may transmit the notification and the level of the notification to the electronic device of the user through the communication module. In this case, when outputting the notification, the electronic device of the user may display the level of the notification together, or may not display the notification having a level less than the designated level in real time according to the setting of the electronic device of the user.

FIG. 13 is a flowchart illustrating a method for providing a notification according to an embodiment of the disclosure.

Referring to FIG. 13, the illustrated flowchart 1300 is merely an embodiment, and the operation order according to various embodiments of the disclosure may be different from that illustrated in FIG. 13, and some of the operations illustrated in FIG. 13 may be omitted, the order between the operations may be changed, or the operations may be merged.

FIG. 13 may be a view illustrating a method in which an electronic device 501 (e.g., the second electronic device 330 of FIGS. 3A and 3B) performs an operation of providing a notification.

In operation 1301, the processor 540 may receive one or more events from one or more first electronic devices through the communication module 510.

The processor 540 may receive one or more events generated from one or more first electronic devices, respectively, via a server 320, from the one or more first electronic devices through the communication module 510.

The one or more events received from the one or more first electronic devices (hereinafter, referred to as “one or more events”) may include one or more events related to intrusion detection.

In operation 1303, the processor 540 may obtain at least one group for the one or more events, based on the times of reception of the one or more events received from the one or more first electronic devices. Operation 1303 is at least partially identical or similar to operation 603 of FIG. 6, and thus a detailed description thereof is omitted.

In operation 1305, the processor 540 may obtain a notification corresponding to at least one group. For example, the processor 540 may obtain (e.g., generate) at least one notification respectively corresponding to the at least one group. Since operation 1305 is at least partially the same as or similar to operation 605 of FIG. 6, a detailed description thereof will be omitted.

In operation 1307, the processor 540 may output the obtained notification. For example, the processor 540 may display a screen including the obtained notification through the display module 520. However, the disclosure is not limited thereto, and the processor 540 may output audio related to the obtained notification through a sound output module (e.g., the sound output module 255 of FIG. 2) or output vibration related to the obtained notification through a haptic module (e.g., the haptic module 279 of FIG. 2).

In an embodiment as described with reference to FIG. 13, the electronic device 501 may perform an operation for providing a notification. Although not illustrated in FIG. 13, the electronic device 501 may perform an operation of providing a notification by performing the same or similar operation as the examples described with reference to FIGS. 6 to 8, 9A to 9C, and 10 to 12. For example, the electronic device 501 may determine whether to output the obtained notification, based on the setting related to the notification. As another example, the electronic device 501 may determine the level of the obtained notification and may determine whether to output the notification according to the determined level of the notification.

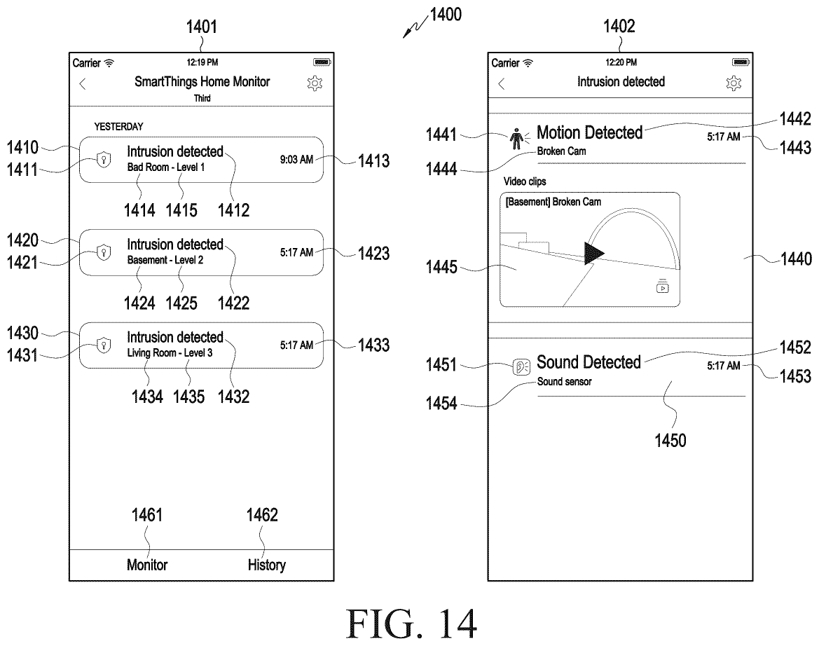

FIG. 14 is a view 1400 illustrating a method for displaying a notification according to an embodiment of the disclosure.

Referring to FIG. 14, the electronic device 501 (e.g., the second electronic device 330 of FIGS. 3A and 3B) may display a notification received from the central device through the display module 520. For example, the electronic device 501 may display a screen 1401 including notification 1 1410, notification 2 1420, and notification 3 1430 through the display module 520.

Notification 1 1410 may include an object 1411 (e.g., an icon) indicating that notification 1 is associated with intrusion detection, a text 1412 indicating intrusion detection, a time 1413 when the first received event among events included in the group corresponding to notification 1 is received by the central device, the room 1414 (e.g., a bed room) registered in association with the electronic device transmitting the event included in the group corresponding to the notification, and a level 1415 (e.g., level 1) of notification 1.

Notification 2 1420 may include an object 1421 indicating that notification 2 is associated with intrusion detection, a text 1422 indicating intrusion detection, a time 1423 when the first received event among events included in the group corresponding to notification 2 is received by the central device, the room 1424 (e.g., a basement) registered in association with the electronic device transmitting the event included in the group corresponding to the notification, and a level 1425 (e.g., level 2) of notification 2.

Notification 3 1430 may include an object 1431 indicating that notification 3 is associated with intrusion detection, a text 1432 indicating intrusion detection, a time 1433 when the first received event among events included in the group corresponding to notification 3 is received by the central device, the room 1434 (e.g., a living room) registered in association with the electronic device transmitting the event included in the group corresponding to the notification, and a level 1435 (e.g., level 3) of notification 3.

The processor 540 may control the display module 520 so that an object indicating that the notification is related to intrusion detection is displayed in a color corresponding to the level of the notification. For example, the processor 540 may control the display module 520 so that the object 1411 indicating that notification 1 is related to intrusion detection is displayed in yellow corresponding to the level (e.g., level 1) of notification 1. As another example, the processor 540 may control the display module 520 so that the object 1421 indicating that notification 2 is related to intrusion detection is displayed in green corresponding to the level (e.g., level 2) of notification 2. As another example, the processor 540 may control the display module 520 so that the object 1431 indicating that notification 3 is related to intrusion detection is displayed in red corresponding to the level (e.g., level 3) of notification 3.

The processor 540 may display a screen 1401 including a history of the notification received by the electronic device through the display module 520, based on a user input to the object 1462. The processor 540 may display, through the display module 520, a screen for making a setting related to an operation of providing a notification, based on a user input to the object 1461.

The processor 540 may display a screen including detailed information about the selected one notification through the display module 520, based on a user input for selecting one notification among the notifications. For example, the processor 540 may display a screen 1402 including detailed information about notification 2 1420 through the display module 520, based on a user input for selecting notification 2 1420.

The screen including the detailed information about the selected notification may include information about each of the events. For example, the screen 1402 including detailed information about notification 2 1420 may include information 1440 indicating a movement-related event and information 1450 indicating a sound-related event.

The information 1440 indicating the movement-related event may include an object 1441 indicating that the movement-related event is obtained, a text 1442 indicating that the movement-related event is obtained, the time 1443 of reception of the event, the name 1444 (or type) of the electronic device transmitting the event, and an image 1445 related to the detected movement.

The information 1450 indicating the sound-related event may include an object 1451 indicating that the sound-related event is obtained, a text 1452 indicating that the sound-related event is obtained, the time 1453 of reception of the event, the name 1454 (or type) of the electronic device transmitting the event, and an object (not shown) for reproducing the detected sound.

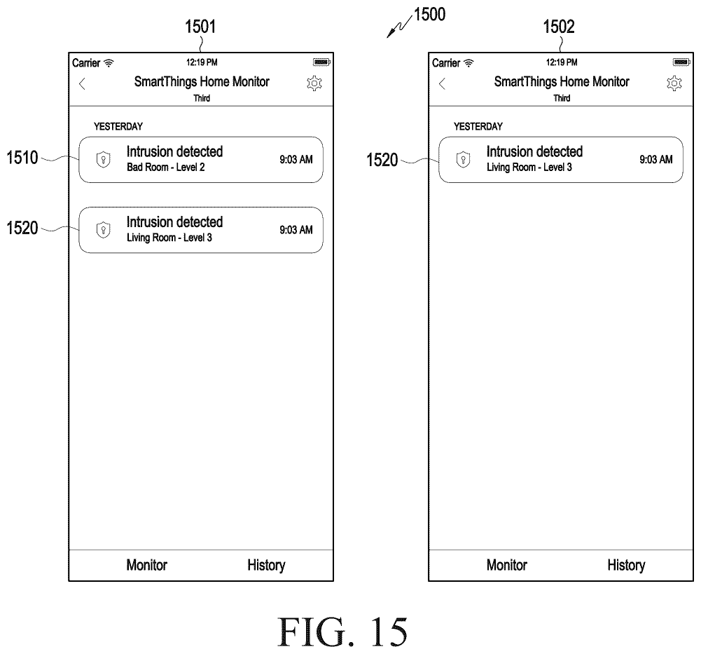

FIG. 15 is a view 1500 illustrating a method for displaying a notification according to an embodiment of the disclosure.

Referring to FIG. 15, the electronic device 501 (e.g., the second electronic device 330 of FIGS. 3A and 3B) may receive a notification having a level equal to or higher than a designated level from the central device, and may display the received notification through the display module 520.

When the designated level is set to level 2, the electronic device 501 may receive notification 1 1510 and notification 2 1520 having levels of level 2 or higher and may display the received notification 1 1510 and notification 2 1520 through the display module 520, as shown in a screen 1501.

When the designated level is set to level 3, the electronic device 501 may receive notification 2 1520 having a level of level 3 or higher and may display the received notification 2 1520 through the display module 520, as shown in a screen 1502.

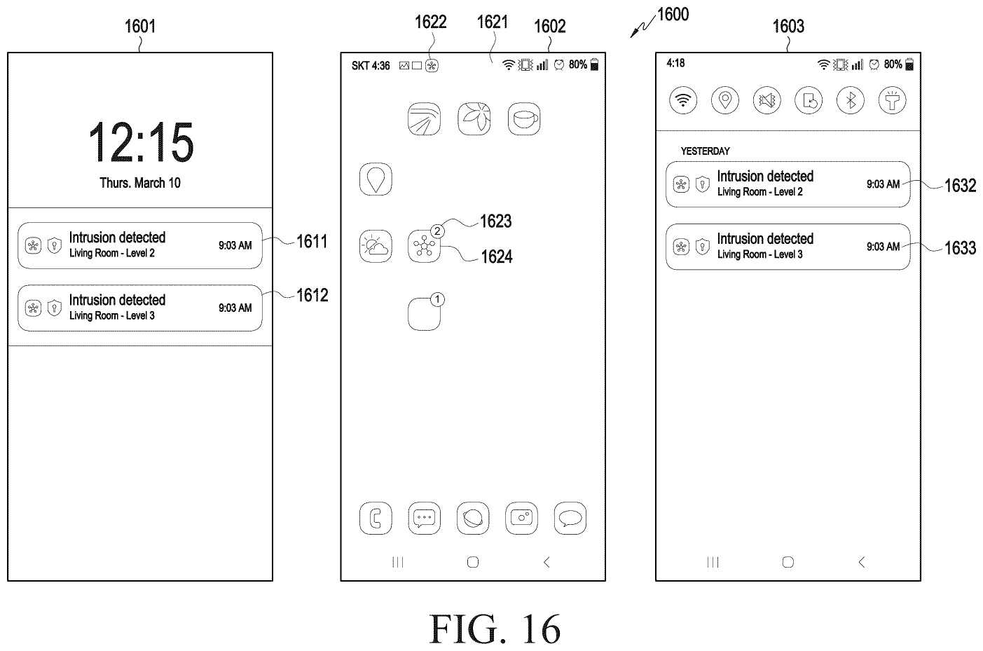

FIG. 16 is a view 1600 illustrating a method for displaying a notification according to an embodiment of the disclosure.

Referring to FIG. 16, when a notification corresponding to a group is received, the processor 540 may display the received notification through the display module 520 in real time in various ways. For example, when a notification is received while the electronic device 501 is in the locked state, the processor 540 may display a lock screen 1601 including notifications 1611 and 1612 received in real time through the display module 520. As another example, when a notification is received, the processor 540 may display, through the display module 520, a home screen 1602 in which an object 1622 indicating that the notification is received is displayed in an indicator area 1621 (e.g., an indicator area indicating the status of the electronic device), and a badge 1623 indicating the number of received notifications is displayed on the icon 1624 of the application providing the notification. As another example, when a notification is received, the processor 540 may display a quick panel 1603 including received notifications 1632 and 1633 through the display module 520.

A method for providing a notification by an electronic device (e.g., the electronic device 401), according to various embodiments, may comprise receiving one or more events from one or more first electronic devices (e.g., the one or more electronic devices 311, 312, and 313) through a communication module (e.g., the communication module 410) of the electronic device, obtaining at least one group for the one or more events with respect to the times of reception of the one or more events, obtaining a notification corresponding to the at least one group, and transmitting the notification to a second electronic device (e.g., the second electronic device 330) through the communication module.

In various embodiments, obtaining the at least one group may include obtaining a group including a first event included in the one or more events and at least one event received within a designated time from a time of reception of the first event.

In various embodiments, obtaining the at least one group may include obtaining the at least one group for the one or more events based on a location and/or a room where the one or more first electronic devices are registered in the electronic device and the times of reception of the one or more events.

In various embodiments, obtaining the at least one group may include obtaining the at least one group for the one or more events based on whether there is an area where ranges in which the one or more first electronic devices are able to obtain an event overlap each other and the times of reception of the one or more events.

In various embodiments, obtaining the at least one group may include obtaining the at least one group for the one or more events based on a distance between the one or more first electronic devices and the times of reception of the one or more events.

In various embodiments, the method may further comprise determining whether to transmit the notification to the second electronic device based on a setting related to the notification. Transmitting the notification to the second electronic device may include transmitting the notification to the second electronic device through the communication module when it is determined to transmit the notification to the second electronic device.

In various embodiments, the setting related to the notification may include a setting about whether the second electronic device receives the notification and/or a setting about a time interval for receiving the notification.

In various embodiments, the method may further comprise determining the level of the notification. Transmitting the notification to the second electronic device may include transmitting the notification to the second electronic device through the communication module when the level of the notification is a designated level or more.

In various embodiments, determining the level of the notification may include determining the level of the notification based on at least one of a capability of the one or more first electronic devices, a type of the one or more events, a probability of malfunction of the one or more first electronic devices, or a sensibility set for the one or more first electronic devices.

Further, the structure of the data used in embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a compact disc read only memory (CD-ROM) or a digital versatile disc (DVD)).

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
communication circuitry;
at least one processor including processing circuitry; and
memory storing instructions that, when by the least one processor individually or collectively, cause the electronic device to:
receive one or more events from one or more first electronic devices through the communication circuitry,
based on times of reception of the one or more events, obtain at least one group for the one or more events,
obtain a notification corresponding to the at least one group, and
transmit the notification to a second electronic device through the communication circuitry.

2. The electronic device of claim 1, wherein the instructions, when by the least one processor individually or collectively, cause the electronic device to obtain a group including a first event included in the one or more events and at least one event received within a designated time from a time of reception of the first event.

3. The electronic device of claim 1, wherein the instructions, when by the least one processor individually or collectively, cause the electronic device to, based on the times of reception of the one or more events and a location and/or a room where the one or more first electronic devices are registered in the electronic device, obtain the at least one group for the one or more events.

4. The electronic device of claim 1, wherein the instructions, when by the least one processor individually or collectively, cause the electronic device to, based on the times of reception of the one or more events and whether there is an area where ranges in which the one or more first electronic devices are able to obtain an event overlap each other, obtain the at least one group for the one or more events.

5. The electronic device of claim 1, wherein the instructions, when by the least one processor individually or collectively, cause the electronic device to, based on the times of reception of the one or more events and a distance between the one or more first electronic devices, obtain the at least one group for the one or more events.

6. The electronic device of claim 1, wherein the instructions, when by the least one processor individually or collectively, cause the electronic device to:
based on a setting related to the notification, determine whether to transmit the notification to the second electronic device; and
based on determining to transmit the notification to the second electronic device, transmit the notification to the second electronic device through the communication circuitry.

7. The electronic device of claim 6, wherein the setting related to the notification includes at least one of a setting about whether the second electronic device receives the notification or a setting about a time interval for receiving the notification.

8. The electronic device of claim 1, wherein the instructions, when by the least one processor individually or collectively, cause the electronic device to:
determine a level of the notification; and
based on the level of the notification being a designated level or more, transmit the notification to the second electronic device through the communication circuitry.

9. The electronic device of claim 8, wherein the instructions, when by the least one processor individually or collectively, cause the electronic device to determine the level of the notification, based on at least one of a capability of the one or more first electronic devices, a type of the one or more events, a probability of malfunction of the one or more first electronic devices, or a sensibility set for the one or more first electronic devices.

10. The electronic device of claim 1,
wherein the one or more events are events related to intrusion detection, and
wherein the electronic device is a hub device communicatively connected to the one or more first electronic devices or a server.

11. A method for providing a notification by an electronic device, the method comprising:
receiving one or more events from one or more first electronic devices through a communication circuitry of the electronic device;
based on times of reception of the one or more events, obtaining at least one group for the one or more events;
obtaining a notification corresponding to the at least one group; and
transmitting the notification to a second electronic device through the communication circuitry.

12. The method of claim 11, wherein obtaining the at least one group comprises obtaining a group including a first event included in the one or more events and at least one event received within a designated time from a time of reception of the first event.

13. The method of claim 11, wherein obtaining the at least one group comprises based on the times of reception of the one or more events and a location and/or a room where the one or more first electronic devices are registered in the electronic device, obtaining the at least one group for the one or more events.

14. The method of claim 11, wherein obtaining the at least one group comprises based on the times of reception of the one or more events and whether there is an area where ranges in which the one or more first electronic devices are able to obtain an event overlap each other, obtaining the at least one group for the one or more events.

15. The method of claim 11, wherein obtaining the at least one group comprises based on the times of reception of the one or more events and a distance between the one or more first electronic devices, obtaining the at least one group for the one or more events.

16. The method of claim 11, further comprising:
based on a setting related to the notification, determining whether to transmit the notification to the second electronic device,
wherein transmitting the notification to the second electronic device comprise:
based on determining to transmit the notification to the second electronic device, transmitting the notification to the second electronic device through the communication circuitry.

17. The method of claim 16, wherein the setting related to the notification includes at least one of a setting about whether the second electronic device receives the notification or a setting about a time interval for receiving the notification.

18. The method of claim 11, further comprising:
determining a level of the notification,
wherein transmitting the notification to the second electronic device comprise:
based on the level of the notification being a designated level or more, transmitting the notification to the second electronic device through the communication circuitry.

19. The method of claim 18, wherein determining the level of the notification comprises:
determine the level of the notification, based on at least one of a capability of the one or more first electronic devices, a type of the one or more events, a probability of malfunction of the one or more first electronic devices, or a sensibility set for the one or more first electronic devices.

20. An electronic device, comprising:
communication circuitry;
a display;
at least one processor including processing circuitry; and
memory storing instructions that, when by the least one processor individually or collectively, cause the electronic device to:
receive one or more events from one or more first electronic devices through the communication circuitry,
based on times of reception of the one or more events, obtain at least one group for the one or more events,
obtain a notification corresponding to the at least one group, and
display the notification through the display module.
